(19) United States
(12) Patent Application Publication
(10) Pub. No.: US 2026/0278422 A1
(43) Pub. Date: Sep. 17, 2026

(54) WORKLOAD AWARE OPTIMIZATIONS FOR INFERENCE TIME SCALING IN AGENTS

(71) Applicant: NVIDIA Corporation, Santa Clara, CA (US)

(72) Inventors: Dhruv Nandakumar, Boston, MA (US); Michael David Demoret, Brooklyn, NY (US); Rachel Allen, Arlington, VA (US); Ryan Olson, Santa Clara, CA (US); John Andrew Blair, III, Towson, MD (US); Kyle Kranen, San Francisco, CA (US); Ishan Dhanani, Santa Clara, CA (US); Alec Flowers, Sunnyvale, CA (US); Bartley Richardson, Santa Clara, CA (US)

(21) Appl. No.: 19/358,991

(22) Filed: Oct. 15, 2025

Related U.S. Application Data
(60) Provisional application No. 63/772,593, filed on Mar. 16, 2025.
(60) Provisional application No. 63/772,598, filed on Mar. 16, 2025.

(51) Int. Cl. G06N 5/043; G06F 17/16

(52) U.S. Cl. CPC G06N 5/043; G06F 17/16

(57) ABSTRACT

A system comprising one or more processors performs operations to optimize workload distribution among artificial intelligence (AI) agents. The system receives inference requests from AI agent workflows, which include metadata on future workload characteristics. The system accesses current load patterns and key-value cache utilization of multiple inference workers and routes the requests to selected subsets of workers based on these factors, ensuring efficient allocation of workloads and effective use of resources.

### CROSS-REFERENCE TO RELATED APPLICATIONS

This application is a non-provisional of and claims priority to U.S. Provisional Application No. 63/772,593, filed Mar. 16, 2025 and U.S. Provisional Application No. 63/772,598, filed Mar. 16, 2025, which are incorporated by reference herein in their entireties.

### TECHNICAL FIELD

This disclosure generally relates to artificial intelligence (AI) agent workflow (e.g., AI and/or language model (LM)) evaluation systems, and more particularly to computer-implemented architectures that facilitate intelligent assessment of AI/LM agent and/or AI agent workflow performance across multiple frameworks.

### BACKGROUND

Current AI agent serving architectures create significant performance optimization blind spots when inference servers route requests from multi-framework agent workflows, where agent clients and LM servers operate in completely decoupled configurations that cannot share predictive workload information. These decoupled systems rely on point-in-time resource availability metrics that provide no visibility into future agent behavior patterns, preventing inference servers from making intelligent routing decisions based on anticipated workload characteristics rather than instantaneous GPU utilization snapshots. This creates fragmented optimization where servers cannot obtain unified predictive insights across heterogeneous AI agent request patterns, resulting in suboptimal resource allocation decisions and missed opportunities for intelligent load balancing based on forecasted future work.

The technical problem extends beyond reactive resource management into the realm of predictive workload characterization, where current serving approaches focus primarily on immediate request processing without addressing future inference performance characteristics, such as anticipated token generation patterns, sequential request prediction, and workload forecasting optimization. Traditional serving architectures only consider the characteristics of individual requests at arrival time, failing to account for the complex behavioral dynamics that emerge from predictable agent execution patterns. With large AI agentic workflows where different execution paths generate sequential LM requests with predictable timing and resource requirements, it becomes difficult to optimize server-side resource allocation when only current load conditions are visible during individual request processing cycles. These conventional approaches force inference systems to make routing decisions based on incomplete visibility into future workload patterns, resulting in suboptimal tail latency, unnecessary computational resource waste, and unpredictable scaling behavior when multiple concurrent agent workflows compete for inference resources without coordinated optimization based on predicted future work requirements.

### BRIEF DESCRIPTION OF THE DRAWINGS

The present systems and methods are described in detail below with reference to the attached drawing figures. To easily identify the discussion of any particular element or act, the most significant digit or digits in a reference number refer to the figure number in which that element is first introduced. In the drawing figures:

FIG. 1 illustrates an AI agent system, according to at least some embodiments of the present disclosure.

FIG. 2 is an AI agent workflow diagram, according to at least some embodiments of the present disclosure.

FIG. 3 illustrates an instrumentation data generation system, according to at least some embodiments of the present disclosure.

FIG. 4 illustrates an evaluation system, according to at least some embodiments of the present disclosure.

FIG. 5 illustrates an evaluation system, according to at least some embodiments of the present disclosure.

FIG. 6 illustrates an evaluation system with a forecasting model, according to at least some embodiments of the present disclosure.

FIG. 7 illustrates an inference server, according to at least some embodiments of the present disclosure.

FIG. 8 is a flowchart illustrating an example method performed by the AI agent system, according to at least some embodiments of the present disclosure.

FIG. 9A is a block diagram of an example generative language model system suitable for use in implementing at least some embodiments of the present disclosure.

FIG. 9B is a block diagram of an example generative LM that includes a transformer encoder-decoder suitable for use in implementing at least some embodiments of the present disclosure.

FIG. 9C is a block diagram of an example generative LM that includes a decoder-only transformer architecture suitable for use in implementing at least some embodiments of the present disclosure.

FIG. 10 is a block diagram of an example computing device suitable for use in implementing at least some embodiments of the present disclosure.

FIG. 11 is a block diagram of an example data center suitable for use in implementing at least some embodiments of the present disclosure.

### DETAILED DESCRIPTION

Systems and methods are disclosed related to workload aware optimizations that improve inference time scaling in AI agent workloads. Specifically, this disclosure generally relates to architectures that utilize predictive metadata about an AI agent’s future workload to make intelligent routing and resource allocation decisions.

The disclosed system provides systems and methods for implementing intelligent online performance optimization through an architecture that enables predictive workload forecasting and metadata-driven inference server routing for AI agent workflows regardless of their underlying implementation frameworks. The technology represents a significant advancement over conventional reactive serving architectures by creating a unified predictive framework (e.g., an AI agent toolkit also referred to as an AI agent system) where trained forecasting models can automatically predict future agent behavior patterns using offline profiling data and attach predictive metadata to inference requests for intelligent server-side optimization decisions. The disclosed system supports comprehensive behavioral pattern learning that enables inference servers to make routing decisions based on predicted future workload rather than point-in-time resource availability, fundamentally transforming how agent-server communication occurs in production deployments. The architecture extends beyond simple request processing to provide predictive workload visibility including expected LM calls, anticipated token generation patterns, and temporal execution sequences that enable server-side optimization strategies previously impossible with reactive serving approaches. This holistic approach enables optimization insights ranging from key-value (KV) cache population decisions and aggregated versus disaggregated serving selection to worker capacity pre-allocation and prompt prefix caching strategies while maintaining agent framework independence and supporting continuous learning through ground-truth feedback mechanisms that improve prediction accuracy during production deployment.

The disclosed techniques can employ multiple optimization methods, including server-native self-reflection processing that executes multi-step reasoning loops within inference server infrastructure to reduce client-server round-trip communications, and workload-aware routing that uses sampling algorithms to make intelligent routing decisions based on both current system load and predicted future workload characteristics. The disclosed system uses bidirectional protocol enhancement techniques that embed structured metadata within inference requests, including anticipated number of reflection iterations, reflection prefix patterns, expected token generation requirements, and temporal execution sequences, thereby enabling inference servers to optimize KV cache utilization through prompt chaining and maintain cache coherency across related self-reflection requests. The disclosed system triggers workload-aware optimization algorithms when predictive metadata is processed by inference servers. These algorithms include exploration versus exploitation routing decisions using sampling techniques that consider current KV cache matches, inference worker load metrics, committed future request counts, and/or opportunity costs for switching between workers, thereby enabling servers to make routing decisions that optimize for long-term latency reduction rather than greedy point-in-time resource availability.

In some examples, the disclosed AI agent system operates through processing circuitry that trains forecasting models using offline profiling data collected from AI agent workflows. These forecasting models learn to predict future workflow behavior patterns and resource utilization characteristics specific to agent execution patterns. During runtime execution of agent workflows, the disclosed AI agent system generates predictive metadata for requests using the trained forecasting models, where this metadata includes estimates of future work, such as expected workflow execution patterns and anticipated resource utilization requirements. The predictive metadata can be embedded within request headers or payload structures sent to inference servers. This includes encoding future work estimates such as expected numbers of subsequent requests and anticipated resource utilization patterns, transmitting timing predictions including expected intervals between consecutive LM calls, and providing cache hint information based on identified common prompt prefixes. Resource allocation decisions are enabled through calculations of expected GPU memory requirements for predicted future ML (machine learning) calls, estimation of total workflow execution time based on historical performance data and current system load, and selection of resource allocations based on expected memory requirements and estimated execution times. The inference server performs capacity planning for current requests and additional requests associated with agent workflows using the predictive metadata.

In some cases, the disclosed system may center around an AI agent system that can transform how inference requests are processed and routed. Namely, the disclosed system may employ one or more processors with specialized processing circuitry that can be designed to handle the complex demands of modern AI agentic workflows. In certain implementations, when the AI agent system receives inference requests from one or more AI agent workflows, these requests may arrive enriched with valuable metadata that can provide insight into future workload characteristics. This forward-looking information may represent a departure from traditional systems that operate in isolation. The processor may simultaneously access current operational data, including load patterns across the system and KV cache utilization statistics from multiple inference workers. In some examples, based on both present conditions and future expectations, the processor (e.g., the AI agent system processor) may route incoming requests to selected subsets of inference workers, potentially optimizing the allocation based on the comprehensive view of both current load patterns and anticipated future workload characteristics.

In some implementations, the disclosed system's intelligence may extend to metadata extraction capabilities. In certain examples, the processor may analyze incoming requests to identify expected numbers of reflection iterations and recognize reflection prefix patterns that could be used for optimization. In some cases, by calculating anticipated token generation requirements for each reflection iteration in advance, the system may format and attach this predictive metadata to inference requests, potentially enabling downstream components to make informed decisions.

In certain embodiments, advanced models that can be designed for workload-aware routing decisions. These models may calculate reward functions for each available inference worker, potentially taking into account both current load patterns and future workload characteristics. In some cases, the routing decisions may flow from these calculated reward functions, potentially creating a dynamic and responsive allocation system. In some implementations, a Thompson sampling process may serve as the mathematical foundation for these routing models. For example, the processor may train bandit algorithms using feature vectors that can capture current load metrics across all inference workers. In some cases, through matrix multiplications, the processor may generate the reward functions that can guide decision-making. As requests complete, the processor may receive latency feedback that can continuously update the bandit matrices, potentially creating a learning system that improves over time.

In certain embodiments, self-reflection capabilities may represent another key aspect. In some examples, the processor may detect self-reflection workflow specifications embedded in the metadata and execute multiple self-reflection iterations without requiring additional requests from the AI agent workflows. This internal processing capability may allow the system to return refined results after completing the reflection process entirely within the inference infrastructure.

Resource allocation intelligence may permeate the system's operations. In certain examples, the processor may analyze request concurrency levels to determine optimal resource allocation strategies and calculate expected GPU memory requirements based on both current load patterns and future workload characteristics. In some cases, the processor may continuously balance current load patterns against predicted future demand from AI agent workflows, potentially ensuring efficient resource utilization. In certain embodiments, proactive optimization may extend to KV cache management, where the processor may transmit KV cache recommendations to selected inference workers, potentially enabling proactive loading that reduces future latency. The processor may generate comprehensive feature vectors incorporating KV cache match levels, current inference worker load metrics, committed future request counts for each inference worker, and estimated timing parameters including inter-request intervals and output generation times.

In some implementations, the decision-making process may involve calculating opportunity costs for switching between inference workers versus maintaining current assignments. Matrix multiplications on feature vectors may generate reward estimates for each available inference worker, while Thompson sampling reward functions may continuously update based on actual latency feedback from completed requests. In some cases, the processor may select optimal inference worker subsets by comparing exploration versus exploitation tradeoffs using these reward functions. KV cache optimization may represent an important performance enhancement. In some examples, the processor may monitor cache utilization across all inference workers and analyze prompt prefix patterns to identify optimization opportunities. In some cases, the processor may calculate KV cache hit probabilities for different worker assignments based on these patterns and generate cache affinity scores that can inform routing decisions.

The future workload characteristics may encompass various predictive elements, including expected numbers of subsequent requests from AI agent workflows and request type patterns that can help anticipate system demands. In certain examples, this forward-looking capability may enable the processor to make decisions that optimize not just immediate performance but long-term efficiency. In some embodiments, the system may incorporate profiling and learning capabilities through offline data collection from AI agent workflow executions. In certain examples, the system may train forecasting models using Hoeffding trees that can be designed for streaming data learning. In some cases, by analyzing execution traces, the system may identify behavioral patterns and resource utilization characteristics, potentially generating training datasets that capture statistical distributions of workflow execution patterns.

In certain implementations, the offline profiling process may involve deep inspection of AI agent workflow source code to identify undeclared agent frameworks and automatically discover LM frameworks used in function definitions. In some examples, the system may analyze code structure and library imports to understand the underlying architecture. In some cases, custom callback handlers may register for each identified agent framework, potentially intercepting framework invocations and extracting crucial information including input data, output data, and token usage from these intercepted calls. Information normalization may occur across different frameworks into a unified data model, with the normalized information potentially being published to intermediate step streams. In certain examples, the system may execute AI agent workflows across multiple concurrency levels while collecting execution traces and generating standardized invocation traces that can capture comprehensive end-to-end workflow execution data.

In some implementations, the forecasting models may operate as Hoeffding trees that can learn from streaming data during production deployment. Pattern mining algorithms may train these models to identify common prompt prefixes across multiple workflow executions. In some cases, the system may calculate expected numbers of LM calls, expected completion tokens, and/or expected time intervals between calls based on historical execution patterns. In some embodiments, runtime updates to forecasting models may occur continuously using ground truth data from completed workflow executions.

In certain implementations, this comprehensive system may find application across numerous domains, including control systems for autonomous and semi-autonomous machines, perception systems, simulation operations, digital twin implementations, light transport simulation, collaborative content creation for three-dimensional (3D) assets, deep learning operations, remote operations, real-time streaming, and augmented, virtual, or mixed reality content generation and presentation. In some examples, the system may operate effectively on edge devices, robotic platforms, conversational AI systems, and various LM implementations including multi-modal, large, small, and vision LMs. In some cases, it may support synthetic data generation, virtual machine environments, inference microservices, containerized machine learning models, data center implementations, and cloud computing resources.

In certain embodiments, the system architecture may extend to comprehensive system implementations that can mirror the processor-based approach while operating at the system level. In some examples, method implementations may follow similar operational patterns, with future workload characteristics potentially encompassing expected numbers of subsequent requests and request type patterns from AI agent workflows. In some cases, these methods may operate across the same diverse range of platforms and applications as the processor-based implementations, potentially ensuring broad applicability across the technology landscape.

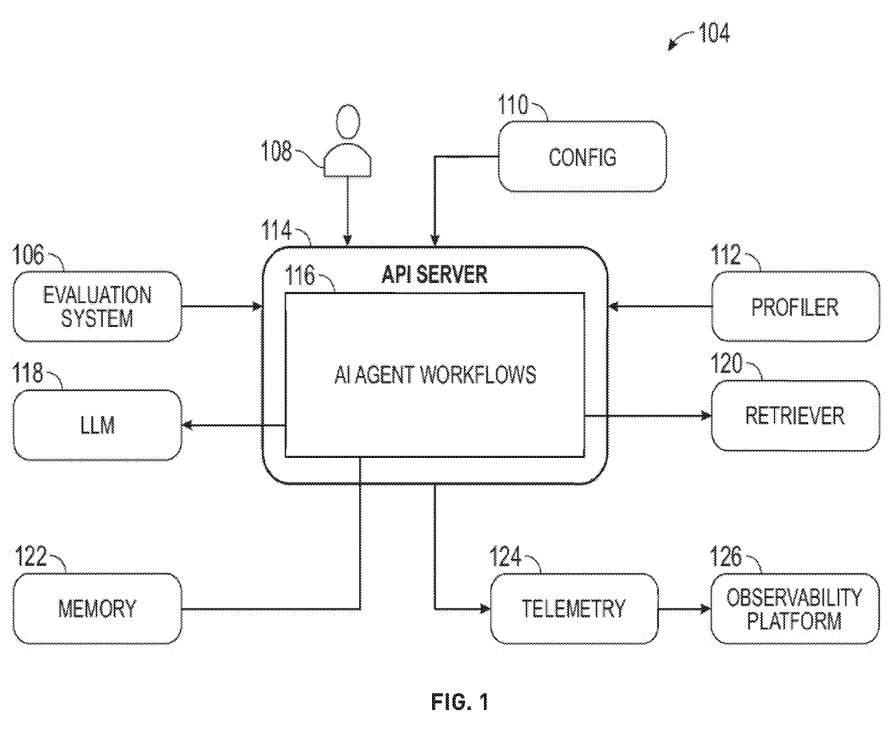

FIG. 1 illustrates an AI agent system 104, according to at least some embodiments of the present disclosure. Specifically, FIG. 1 illustrates a comprehensive AI agent system 104 that may enable framework-agnostic performance analysis and evaluation of AI agent workflows 116 across multiple implementation frameworks. The AI agent system 104 may provide a unified platform for analyzing AI agent workflow (also referred to as agents or AI agents) performance regardless of whether the agents are implemented in LangChain, LlamaIndex, CrewAI, Semantic Kernel, or other agent frameworks. The architecture may support both offline profiling and real-time observability of agent workflows while maintaining compatibility with existing agent development frameworks.

The AI agent system 104 illustrated in FIG. 1 provides a comprehensive framework-agnostic platform that enables both offline profiling and online predictive optimization of AI agent workflows 116 across multiple implementation frameworks. This architecture serves as the foundation for the online profiling capabilities that enable predictive metadata generation and intelligent inference server routing decisions based on anticipated workflow behavior patterns.

A central component API server 114 may serve as the primary interface through which users, such as a user 108, interact with the AI agent system 104 system. This API server 114 component may receive requests from developers seeking to analyze their agent workflows and may coordinate the various analysis and profiling operations across the system. The API server 114 may provide standardized endpoints that allow developers to submit their agent workflows for analysis without requiring modifications to their existing agent implementations. The API server 114 serves as the central interface through which developers interact with the AI agent system 104 to submit agent workflows for both offline analysis and online optimization. The API server 114 coordinates framework discovery operations that identify which agent frameworks are being used in submitted workflows through both manual declaration and automated detection capabilities. For automated framework detection, the API server 114 inspects source code at build time to identify undeclared agent frameworks by analyzing code structure, library imports, function signatures, and dependency declarations, enabling comprehensive instrumentation across heterogeneous agent implementations that forms the basis for predictive model training.

In some examples, configuration 110 stores and manages configuration parameters that define how different agent frameworks should be instrumented for both offline profiling and online forecasting operations. This configuration 110 specifies evaluation criteria for different types of agent workflows, defines metrics collection parameters during analysis, and establishes the training parameters for forecasting models that will predict future workflow behavior patterns and resource utilization characteristics. The configuration 110 also determines which observability platforms receive exported trace data and defines the metadata formats used for attaching predictive information to inference requests. The configuration 110 may store and manage configuration parameters for the various analysis operations performed by the system. This configuration 110 may contain settings that define how different agent frameworks should be instrumented, what metrics should be collected during analysis, and how concurrent request simulations should be conducted.

In some examples, developers (e.g., the user 108) may upload their workflows through multiple mechanisms, including direct code submission via REST API endpoints, configuration file uploads using YAML-based workflow definitions, and/or through integration with existing development environments where the API server 114 can access workflow repositories or containerized agent implementations. The API server 114 may implement both manual and/or automated framework detection capabilities to identify which agent frameworks are being used in submitted workflows. For manual detection, developers may explicitly declare the frameworks they are using through configuration parameters or metadata tags when submitting their workflows, such as specifying LangChain, LlamaIndex, CrewAI, Semantic Kernel, or other supported frameworks. The AI agent system 104 may provide standardized configuration templates that allow developers to indicate which frameworks power different components of their multi-framework agent implementations.

For automated framework detection, the API server 114 may coordinate with framework discovery components that inspect source code at build time to identify undeclared agent frameworks. This automated detection process may analyze code structure, library imports, function signatures, and dependency declarations to infer which agent frameworks are being used even when not explicitly declared by developers. The AI agent system 104 may employ pattern matching algorithms that recognize framework-specific coding patterns, API calls, and data structures characteristic of different agent frameworks. Once frameworks are identified through either manual declaration or automated discovery, the API server 114 may coordinate the registration of appropriate custom callback handlers for each detected framework, enabling comprehensive instrumentation and analysis capabilities across heterogeneous agent implementations.

The AI agent workflows 116 may represent the target agent implementations that are being analyzed by the system. These AI agent workflows 116 may be implemented using any combination of supported agent frameworks and may contain complex hierarchies of agents, tools, and other components. The AI agent workflows 116 may include agents built in LangChain that interact with tools developed in LlamaIndex, and/or may consist of single-framework implementations that still benefit from the cross-framework analysis capabilities provided by the system.

A profiler component 112 performs comprehensive offline inference performance analysis that serves as the foundation for training forecasting models used in online optimization. The profiler component 112 simulates multiple concurrent users interacting with agent workflows to collect execution traces that capture behavioral patterns, token usage characteristics, and timing information across different concurrency levels. This profiler component 112 generates the training data necessary for forecasting models by analyzing latency patterns, identifying common prompt prefixes through pattern mining algorithms, and characterizing resource utilization patterns that enable prediction of future workflow behavior during runtime execution.

An evaluation system 106 may assess agent workflows from multiple perspectives including accuracy, relevance, and/or behavioral performance characteristics. This evaluation system 106 may work with standardized evaluation datasets to provide consistent assessment criteria across different agent implementations. The evaluation system 106 may generate performance efficiency metrics that help developers understand how their agents behave under various operational conditions and may identify areas where workflow performance could be improved.

During operation, callback handlers of the AI agent system 104 intercept framework invocations including LM calls, tool calls, and retriever calls across all supported frameworks to extract comprehensive metadata for both offline analysis and online prediction. When an agent workflow executes, these handlers extract metadata including input data, output data, token usage statistics, execution timestamps, and function ancestry information from each intercepted invocation. This metadata extraction enables both the offline profiling that trains forecasting models and the real-time workflow state monitoring that allows forecasting models to generate predictive metadata during runtime execution.

The extracted metadata from all components undergoes normalization across different frameworks into a unified data model that gets published to an intermediate step stream, enabling consistent analysis and prediction capabilities regardless of the originating framework. This normalization process is enabled by the AI agent system's approach of wrapping individual functions with standardized input schemas, output schemas, and descriptions, regardless of whether those functions represent agents, tools, LLMs (large language models), or other workflow components. By wrapping each function in this standardized interface, the toolkit creates a common abstraction layer that allows framework-specific data structures to be converted into the unified data model. This function wrapping mechanism ensures that LLM events, tool events, and other workflow events appear identical regardless of their originating framework, since all wrapped functions conform to the same standardized format with defined inputs, outputs, and descriptions. The standardized intermediate step stream enables forecasting models to process execution events consistently across heterogeneous agent implementations and generate predictive metadata that maintains semantic consistency across all supported frameworks, providing a framework-agnostic foundation for data collection, normalization, and predictive analysis capabilities.

A LM 118 component may represent LM integrations that are monitored and analyzed by the AI agent system 104. The system may track LM inference requests, measure response times, and analyze token utilization patterns for prompt tokens versus completion tokens. The LM 118 analysis may help developers understand the efficiency of their LM usage and may identify opportunities for prompt reduction or caching.

A retriever component 120 may handle retrieval operations that are instrumented by the system for performance analysis. The AI agent system 104 may monitor retriever latency, analyze query patterns, and identify retrieval bottlenecks that impact overall agent workflow performance. The retriever component 120 analysis may provide insights into how retrieval operations contribute to end-to-end workflow latency.

A memory 122 component may represent memory management operations that are tracked by the performance analysis system. The AI agent system 104 may monitor memory usage patterns, analyze conversation history management efficiency, and identify memory-related bottlenecks in agent workflows. The memory 122 analysis may help developers understand how memory operations impact workflow performance across different concurrency levels.

The LM 118, retriever component 120, and memory 122 components represent the instrumented workflow elements that are monitored during both offline profiling and online execution to enable predictive optimization. The LM 118 component tracks LM inference requests, measures response times, and analyzes token utilization patterns that feed into forecasting models for predicting future token generation and timing characteristics. The retriever component 120 and memory 122 components provide execution data about retrieval operations and memory management that contribute to the comprehensive behavioral profiles used to train forecasting models for predicting complete workflow execution patterns and resource requirements.

For example, the extracted metadata normalization process operates by taking framework-specific data structures and converting them into a standardized intermediate representation that maintains semantic consistency across all supported agent frameworks. Namely, when a LangChain agent makes an LLM call, the callback handler extracts metadata that might include LangChain-specific fields such as: langchain.schema.messages.AIMessage; objects with nested content; and additional_kwargs fields, alongside timing data in LangChain's proprietary format. Simultaneously, when a LlamaIndex agent performs a similar LLM operation, its callback handler captures metadata in LlamaIndex's native format, which could include: llama_index.core.base.llms.types.ChatMessage objects with different field structures and timestamp representations. The normalization engine then transforms both of these disparate data structures into a unified format that includes standardized fields such as: input_text, output_text, prompt_tokens, completion_tokens, latency_ms, timestamp_iso, and function_ancestry, ensuring that an LLM call appears identical regardless of whether it originated from LangChain, LlamaIndex, CrewAI, or any other supported framework.

The intermediate step stream serves as the central nervous system for this standardized data flow, implementing a reactive publisher-subscriber architecture that maintains event ordering and hierarchy relationships across framework boundaries. When normalized metadata events are published to the stream, they can include enriched contextual information such as parent-child function relationships, execution depth levels, and cross-framework correlation identifiers that enable comprehensive workflow analysis. For instance, if an agent workflow begins with a LangChain ReAct agent that calls a LlamaIndex retriever tool, which subsequently invokes a CrewAI sub-agent, the intermediate step stream maintains a complete ancestry chain showing how langchain_react_agent.execute() called llamaindex_retriever.search(), which then called crewai_specialist.analyze(). Each event in the stream contains standardized metadata fields including execution timestamps (e.g., start_time: 2025-01-15T14:30:25.123Z), token utilization metrics (e.g., prompt_tokens: 1247, completion_tokens: 389), and performance indicators (e.g., execution_duration_ms: 2340), enabling downstream subscribers to perform consistent analysis regardless of the underlying framework complexity.

This standardization process enables powerful cross-framework observability capabilities where evaluation subscribers, profiler subscribers, and observability platform exporters can all consume the same unified data stream without requiring framework-specific parsing logic. The stream supports multiple concurrent subscribers that can filter and process events based on standardized criteria, such as identifying all LLM calls with completion token counts exceeding, for example, 500 tokens or tracking function execution paths that span more than three different frameworks. Additionally, the intermediate step stream maintains ordering guarantees and supports replay capabilities, allowing profiler algorithms to reconstruct complete workflow execution timelines and identify performance bottlenecks at any level of the execution hierarchy, whether they occur within individual framework boundaries or at framework transition points where data must be marshaled between different agent implementations.

A telemetry component 124 collects and manages performance metrics generated during both offline profiling and online execution, supporting the continuous learning capabilities of forecasting models through ground-truth feedback mechanisms. The telemetry system gathers timing data, resource utilization statistics, and workflow execution traces that enable both initial training of forecasting models and ongoing model updates during production deployment. The telemetry component 124 supports multiple subscriber types that can access performance data for training forecasting models, generating predictive metadata, and providing feedback for model improvement based on actual workflow execution outcomes.

The AI agent system 104 may simulate user load patterns by varying the number of simultaneous requests processed by agent workflows. During these simulations, the AI agent system 104 may collect execution traces that capture end-to-end workflow execution data including function ancestry information and hierarchical relationships between workflow components. These traces may enable the identification of performance bottlenecks that only become apparent under concurrent load conditions.

An observability platform 126 component receives exported trace data in OpenTelemetry-compatible formats while also supporting the export of predictive metadata and forecasting model performance metrics for comprehensive monitoring of both offline analysis and online optimization operations. The AI agent system 104 converts intermediate steps into framework-specific visualization formats and exports predictive accuracy metrics that enable monitoring of forecasting model performance across different agent implementations. This capability enables cross-framework observability where both historical profiling data and real-time predictive metadata can be visualized using tools associated with different frameworks.

The comprehensive integration of offline profiling capabilities with online forecasting functionality enables the AI agent system 104 to provide intelligent resource allocation and request routing based on predicted future workload rather than point-in-time resource availability. The system maintains continuously learning forecasting models that adapt during production deployment using ground-truth data from completed workflow executions, enabling progressive improvement of predictive accuracy over time. This holistic approach enables optimization insights ranging from KV cache population decisions and aggregated versus disaggregated serving selection to worker capacity pre-allocation and prompt prefix caching strategies, allowing inference servers to reduce tail latency and optimize resource allocation across concurrent agent workflow executions through predictive workload management that was previously impossible with reactive serving architectures.

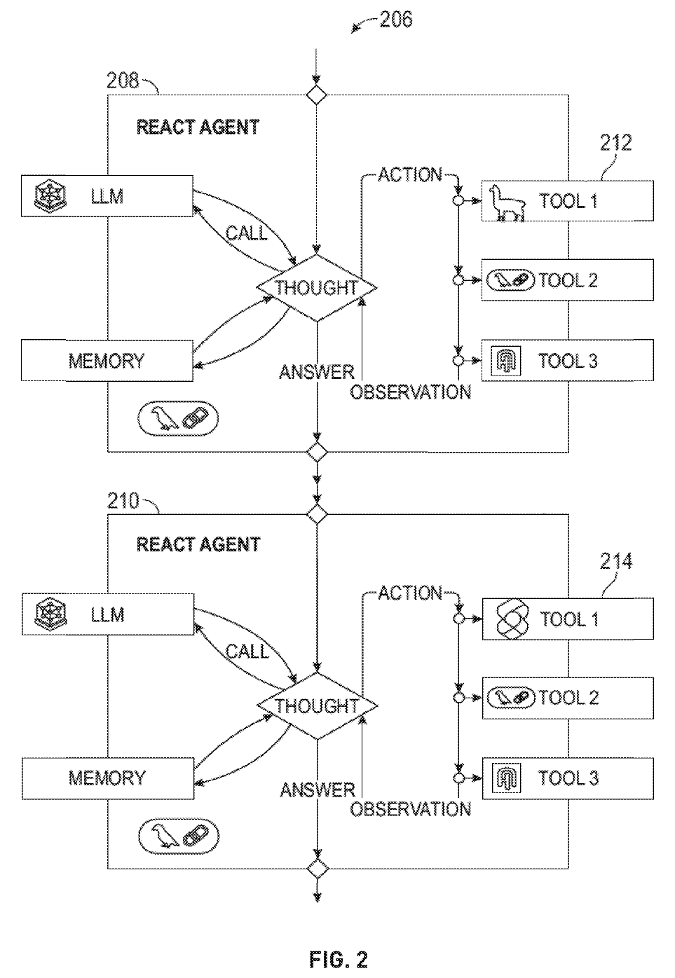

FIG. 2 is an AI agent workflow diagram 206, according to at least some embodiments of the present disclosure. Specifically, FIG. 2 illustrates the framework-agnostic capabilities of the AI agent system 104 system, demonstrating how multiple AI agent workflows created using different frameworks can be seamlessly integrated and analyzed through the unified instrumentation approach. The AI agent workflow diagram 206 shows two distinct ReAct agent implementations that may operate using different underlying frameworks while being monitored and analyzed through the same standardized data collection mechanisms.

A first AI agent workflow 208 represents a ReAct agent implementation that follows the standard reasoning and action cycle common to tool-calling agent systems. This first AI agent workflow 208 may operate by receiving input from users and processing it through a sequence involving an LLM component that reasons about the problem, determines which tools are needed, and coordinates the execution of those tools. The ReAct pattern shown enables the first AI agent workflow 208 to think through problems systematically, take actions using available tools, observe the results, and continue this cycle until reaching a satisfactory conclusion.

A first set of tools 212 associated with the first AI agent workflow 208 includes Tool 1, Tool 2, and Tool 3, each of which may be implemented using different frameworks or methodologies. These tools represent various capabilities that the agent can leverage to accomplish its objectives, such as information retrieval, data processing, mathematical calculations, or external API interactions. The AI agent system 104 system can instrument and monitor each of these tools regardless of their underlying implementation framework through the standardized callback handler system.

A second AI agent workflow 210 demonstrates the system's ability to handle multiple concurrent or related agent implementations that may utilize entirely different frameworks from the first workflow. This second ReAct agent follows the same general pattern of reasoning and action but may be optimized for different types of tasks or may represent an alternative implementation approach. The ability to simultaneously monitor and analyze multiple agent workflows enables developers to compare performance characteristics and behavioral patterns across different implementations. A second set of tools 214 provides additional capabilities that may complement or overlap with the tools in the first set, illustrating how the AI agent system 104 can manage complex multi-agent environments where different agents may share resources or operate on related tasks. The standardized instrumentation approach ensures that tool interactions and performance metrics can be collected consistently across both agent workflows, enabling comprehensive analysis of the entire multi-agent system.

The memory component shown in both workflows represents the conversation history and context management capabilities that enable agents to maintain state across multiple interactions. The AI agent system 104 can monitor memory operations to understand how conversation context affects agent performance and identify potential bottlenecks related to memory retrieval or storage operations. This monitoring capability extends across different memory implementations regardless of the underlying framework used.

The LLM components in both workflows represent the LM integration points that are important to agent operation. The system's callback handlers can intercept and monitor LLM calls from both agents, collecting standardized metrics including input token counts, output token counts, response latencies, and usage patterns. This unified monitoring approach enables cross-agent comparison of LM efficiency and identification of optimization opportunities.

The standardized intermediate step stream functionality enables both agent workflows to publish their execution events to the same unified data model, regardless of their underlying framework implementation. When either agent workflow executes, the custom callback handlers extract metadata from framework invocations and normalize this data across the different frameworks into the common format. This normalization process ensures that evaluation subscribers, profiler subscribers, and observability platform exporters can process events from both agents using the same analysis algorithms.

The AI agent workflow diagram 206 illustrates how the AI agent system's framework-agnostic abstractions enable complex multi-agent scenarios where different agents built using different frameworks can be deployed, monitored, and analyzed as part of a unified system. This capability allows developers to leverage the strengths of different frameworks while maintaining comprehensive observability and analysis capabilities across their entire agent ecosystem, supporting more sophisticated deployment scenarios and enabling detailed performance comparisons between different implementation approaches.

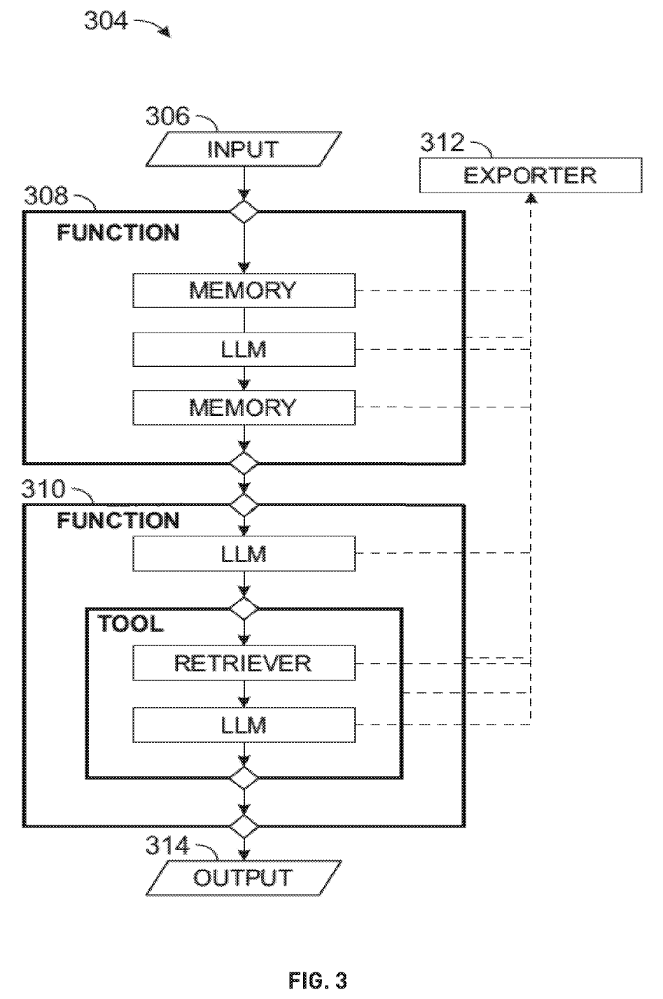

FIG. 3 illustrates an instrumentation data generation system 304, according to at least some embodiments of the present disclosure. Specifically, FIG. 3 illustrates the instrumentation data generation system 304 that demonstrates how the AI agent system 104 processes and standardizes data from multiple AI agent workflows regardless of their underlying framework implementations. This instrumentation data generation system 304 represents a component of the offline inference performance analysis capabilities, showing the flow of data from initial input 306 through various agent workflow components to final output 314, while simultaneously generating standardized instrumentation data through an exporter component 312.

The input 306 represents the starting point where user queries and/or evaluation datasets enter the instrumentation data generation system 304. This input may contain various types of requests that need to be processed by AI agent workflows, similar to how the API server 114 described in FIG. 1 receives requests from developers seeking to analyze their agent workflows. The input 306 feeds into the standardized processing pipeline that enables framework-agnostic analysis of agent behavior across different implementation approaches.

A first AI agent workflow 308 demonstrates one possible agent implementation that includes memory components, LM 118 integration, and additional memory management capabilities. This first AI agent workflow 308 represents how agents built in frameworks such as LangChain or LlamaIndex may be structured, with memory components handling conversation history and context management, while the LM 118 component processes reasoning and response generation tasks. The standardized interface approach allows the system to instrument this workflow regardless of its specific framework implementation.

A second AI agent workflow 310 illustrates an alternative agent architecture that incorporates LM 118 capabilities, tool integrations, retriever component 120 functionality, and additional LM 118 processing stages. This second AI agent workflow 310 demonstrates the flexibility of the instrumentation system to handle diverse agent implementations, including those that utilize retrieval-augmented generation patterns through the retriever component 120, multi-step reasoning processes, and complex tool interaction sequences that may span multiple framework boundaries.

The first AI agent workflow 308 and second AI agent workflow 310 may be built using different underlying frameworks to demonstrate the system's framework-agnostic capabilities. For example, the first AI agent workflow 308 might be implemented using LangChain while the second AI agent workflow 310 could be built using LlamaIndex or CrewAI. The architectural differences between these workflows illustrate the diversity of agent implementations that the AI agent system can support. The second AI agent workflow 310 includes both retriever component 120 functionality and multiple LM 118 processing stages because it may implement a retrieval-augmented generation pattern where the second AI agent workflow 310 needs to search external knowledge bases or vector databases to enhance its responses with contextual information. In contrast, the first AI agent workflow 308 focuses on memory-based processing without external retrieval, representing a simpler conversational agent that relies primarily on conversation history and context management through its memory components. This diversity in architectural patterns demonstrates how the instrumentation data generation system 304 can standardize and analyze performance across different agent implementations regardless of whether they utilize retrieval operations, multiple reasoning steps, or varying combinations of tools and frameworks.

The connection between the first AI agent workflow 308 and second AI agent workflow 310 through the intermediate processing stages shows how the instrumentation data generation system 304 maintains data flow and context across different agent implementations. This interconnection enables the profiler component 112 and evaluation system 106 described in FIG. 1 to collect comprehensive execution traces that capture end-to-end workflow execution data, including function ancestry information and hierarchical relationships between workflow components as they transition between different agent implementations.

The exporter component 312 plays a role in the instrumentation data generation system 304 by extracting standardized metadata from the executing workflows and converting framework-specific events into the unified intermediate step stream format. This exporter component 312 implements the custom callback handlers that intercept framework invocations including LM 118 calls, tool calls, and retriever component 120 operations, extracting relevant metadata such as input data, output data, token usage, and execution timestamps from each intercepted invocation and normalizing this data across different frameworks.

The data flow from both agent workflows toward the exporter component 312 demonstrates how the instrumentation data generation system 304 collects performance and behavioral data from multiple concurrent or sequential agent executions. The exporter component 312 receives events from functions publishing normalized metadata to the intermediate step stream, appends hierarchy metadata including parent function calls and ancestry information to each event, and maintains the comprehensive ledger of actions taken by the agent workflows during processing that enables the advanced profiling capabilities described in the system architecture.

The output 314 represents the final stage where processed results from the agent workflows are delivered to users or downstream systems, while the exporter component 312 simultaneously generates standardized instrumentation data that feeds into the telemetry component 124 and observability platform 126 infrastructure shown in FIG. 1. This dual output approach ensures that agent workflows can continue to operate normally while providing comprehensive performance monitoring and analysis capabilities.

The standardized format generation shown through the exporter component 312 enables the cross-framework observability capabilities where AI agent workflows built in one framework can be visualized using tools associated with different frameworks. This standardization process ensures that LM events, tool events, and other workflow events appear identical regardless of their originating framework, supporting the unified analysis capabilities that distinguish this system from framework-specific solutions.

The instrumentation data generation system 304 shown in FIG. 3 provides the data collection and normalization capabilities that enable the profiling algorithms implemented by the profiler component 112, including latency analysis across different parts of agent workflows, nested bottleneck analysis using function ancestry tracking, concurrency analysis for identifying regions of high concurrency in workflow executions, and token efficiency measurements that examine input token versus completion token ratios across different workflow stages.

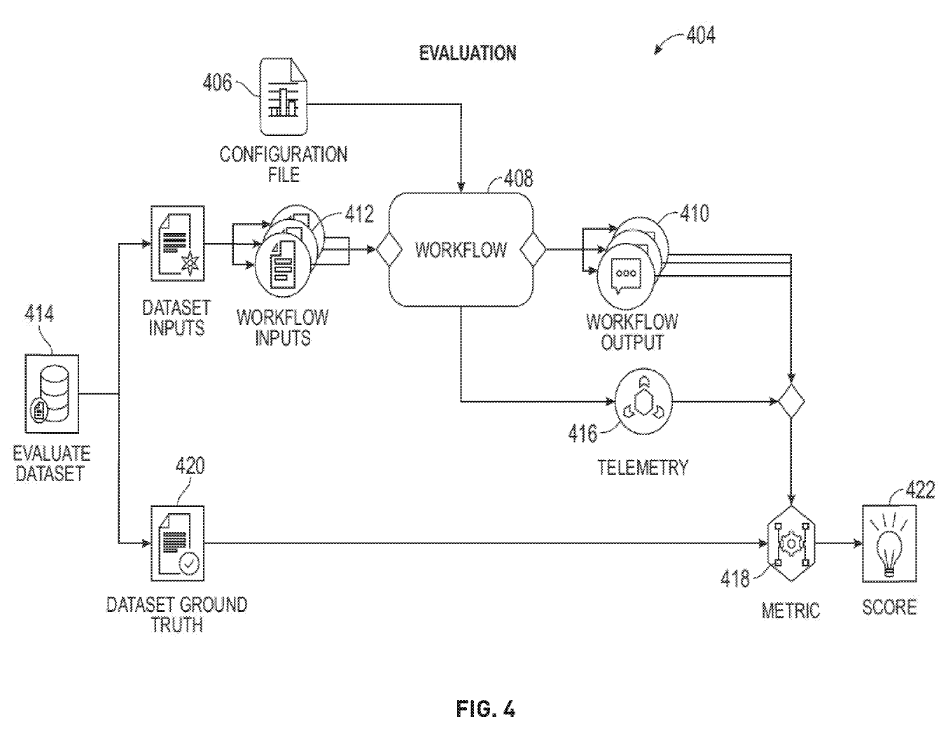

FIG. 4 illustrates an evaluation system 404, according to at least some embodiments of the present disclosure. Specifically, FIG. 4 illustrates the evaluation system 404 that demonstrates how the AI agent system 104 processes and evaluates AI agent workflows 116 through a comprehensive offline analysis approach. This evaluation system 404 represents the evaluation capabilities that enable developers to assess both the performance characteristics and behavioral patterns of their agent implementations across different frameworks. The evaluation system 404 provides a standardized methodology for analyzing agent workflows regardless of their underlying implementation complexity or framework diversity.

A configuration file 406 serves as the component that defines the parameters and settings for the evaluation process. This configuration file 406 may specify which evaluation metrics should be applied, what concurrency levels should be tested during the analysis, and how the evaluation dataset should be processed. The configuration file 406 enables developers to customize their evaluation approach while maintaining consistency across different evaluation runs and allowing for reproducible analysis results that can be compared across different agent implementations.

An AI agent workflow 408 represents the target system being evaluated, which may encompass any combination of agents, tools, and framework implementations that have been instrumented by the AI agent system 104. The AI agent workflow 408 receives input 412 from the evaluation process and generates output 410 that will be analyzed for performance and behavioral characteristics. This AI agent workflow 408 (e.g., the AI agent workflows 116) may contain the complex multi-framework agent implementations described in previous figures, including ReAct agents, retrieval systems, and various tool integrations that operate across different agent frameworks.

An evaluation dataset 414 provides the standardized inputs that are used to systematically test the AI agent workflow 408 across various scenarios and conditions. This evaluation dataset 414 may contain representative queries, requests, or tasks that reflect real-world usage patterns and enable comprehensive testing of agent capabilities. The evaluation dataset 414 works in conjunction with the input 412 component to ensure that agent workflows are tested with consistent and meaningful data that can reveal performance patterns and behavioral insights.

During the evaluation process, the evaluation system 404 collects instrumentation data 416 from the executing AI agent workflow 408. This instrumentation data 416 represents the comprehensive telemetry and execution traces that are gathered through the custom callback handlers and intermediate step stream mechanisms described in previous figures. The instrumentation data 416 includes timing information, token usage statistics, function ancestry data, and other performance-related metadata that enables detailed analysis of agent behavior during execution.

In some examples, during the evaluation process, the evaluation system 404 collects instrumentation data 416 from the executing AI agent workflow 408 through a multi-layered approach that operates transparently during workflow execution. The collection process begins when developers submit their agent workflows to the system through various upload mechanisms, including direct code submission via REST API endpoints, configuration file uploads using YAML-based workflow definitions, or through integration with existing development environments where the API server can access workflow repositories or containerized agent implementations. The system supports both ZIP file uploads containing complete workflow implementations and direct integration with version control systems, enabling seamless incorporation of existing agent development workflows without requiring significant modifications to developers' existing codebases.

The instrumentation data 416 collection process relies on both manual and automated framework detection capabilities to identify which agent frameworks are being used in submitted workflows. For manual detection, developers can explicitly declare the frameworks they are using through configuration parameters or metadata tags when submitting their workflows, such as specifying LangChain, LlamaIndex, CrewAI, Semantic Kernel, or other supported frameworks. The system provides standardized configuration templates that allow developers to indicate which frameworks power different components of their multi-framework agent implementations, enabling precise control over the instrumentation process. This manual approach ensures that developers can specify exactly which frameworks require monitoring and can provide additional context about framework-specific configurations that may affect data collection.

For automated framework detection, the system employs sophisticated code analysis techniques that inspect source code at build time to identify undeclared agent frameworks without requiring explicit developer input. This automated detection process analyzes code structure, library imports, function signatures, and dependency declarations to infer which LLM frameworks are being used even when not explicitly declared by developers. The system uses pattern matching algorithms that recognize framework-specific coding patterns, API calls, and data structures characteristic of different agent frameworks, such as identifying LangChain's callback mechanisms, LlamaIndex's service context patterns, or CrewAI's agent instantiation methods. Once frameworks are identified through either manual declaration or automated discovery, the system coordinates the registration of appropriate custom callback handlers for each detected framework, enabling comprehensive instrumentation and data collection capabilities across heterogeneous agent implementations, ensuring that instrumentation data 416 captures complete execution traces regardless of the underlying framework complexity.

A metric generation component 418 processes the collected instrumentation data 416 to produce quantitative assessments of agent performance and behavior through algorithmic analysis that operates across multiple dimensions of workflow execution. This metric generation component 418 implements latency analysis algorithms that can dissect timing patterns at granular levels, measuring individual LLM inference times, tool execution durations, and end-to-end workflow completion times across different concurrency scenarios. The metric generation component 418 transforms the raw execution data into meaningful performance indicators that developers can use to understand and improve their agent implementations. For example, when analyzing a multi-agent workflow that processes customer support tickets, the metric generation component 418 might identify that while the initial ticket classification LLM call averages 1.2 seconds under single-request conditions, this same operation degrades to 3.8 seconds when processing 8 concurrent requests, indicating potential resource contention that requires infrastructure scaling or request throttling strategies.

The bottleneck identification capabilities of the metric generation component 418 leverage the hierarchical function ancestry data captured through the intermediate step stream to pinpoint performance degradation at unprecedented granular levels across framework boundaries. By analyzing execution timestamps in conjunction with function call hierarchies, the metric generation component 418 can identify that within a complex RAG-enhanced agent workflow, the specific bottleneck occurs not in the primary LLM reasoning step, but in a nested retriever component that performs vector similarity searches within a LlamaIndex tool called by a LangChain parent agent. For instance, the analysis might reveal that 73% of total workflow latency stems from a single Pinecone vector database query operation buried three function calls deep in the execution tree, enabling developers to target optimization efforts precisely rather than attempting broad-spectrum performance improvements.

The concurrency analysis algorithms implemented by the metric generation component 418 automatically detect workflow execution patterns that exhibit high concurrent processing regions and correlate these with LLM inference latency spikes to provide deployment optimization insights. These algorithms can identify scenarios where certain agent functions naturally parallelize tool calls or spawn concurrent sub-agents, measuring how hardware limitations manifest during these peak concurrent periods. Additionally, the token efficiency analysis generates standardized metrics that track prompt token versus completion token ratios across different stages of agent workflows, enabling developers to identify opportunities for prompt optimization, response caching, or model selection adjustments that could significantly reduce both inference costs and latency while maintaining output quality.

In some examples, the evaluation system 404 extends beyond performance analysis to enable comprehensive behavioral pattern extraction that serves as the foundation for training predictive forecasting models (which may be implemented as part of the profiler component 112 of FIG. 1) used in online inference optimization. During the evaluation process, the instrumentation data 416 collection captures not only performance metrics but also detailed behavioral characteristics including workflow execution patterns, timing relationships between function calls, token generation patterns, and resource utilization sequences that characterize how agent workflows behave across different execution scenarios. This comprehensive behavioral data collection enables the evaluation system 404 to generate the training datasets necessary for forecasting models that can predict future agent behavior during runtime execution.

The evaluation system 404 implements pattern mining algorithms, specifically PrefixSpan, that automatically analyze the collected instrumentation data 416 to identify common prompt prefixes across multiple agent workflow executions. These pattern mining algorithms examine input prompts from LM requests captured through the intermediate step stream and apply configurable frequency thresholds to determine which prompt structures occur frequently enough to be considered common patterns worthy of caching optimization. The identification of common prompt prefixes enables the evaluation system 404 to generate cache optimization metadata that can be incorporated into predictive information sent to inference servers (part of the AI agent system 104), allowing for, for example, intelligent KV cache population decisions based on anticipated prompt reuse patterns.

The metric generation component 418 processes the collected behavioral data to extract usage metadata that characterizes the temporal and resource utilization patterns of agent workflow execution. This usage metadata includes workflow execution timing, intervals between consecutive LM calls, expected completion token generation patterns, and resource consumption profiles contextualized to each function within the agent workflow. The metric generation component 418 analyzes execution traces to isolate behavioral characteristics of individual functions, identifying when and how each function utilizes LMs, tools, and other workflow components, creating comprehensive behavioral profiles that serve as training data for forecasting models.

The evaluation system 404 incorporates specialized forecasting model training capabilities that utilize the collected usage metadata to train predictive models such as Hoeffding trees that can learn from streaming data during production deployment. These forecasting models are trained to predict future workflow behavior patterns including expected numbers of function calls remaining, anticipated completion token generation, expected execution timing, and resource utilization characteristics based on historical execution patterns captured during the evaluation process. Since each forecasting model predicts specific metrics, the evaluation system 404 trains separate specialized models for different prediction targets and/or AI agent workflows, enabling granular forecasting of various workflow behavioral aspects.

The training process implemented by the evaluation system 404 executes agent workflows using the evaluation dataset 414 across multiple concurrency levels to simulate diverse user load patterns and generate comprehensive training data for the forecasting models. The system 404 analyzes execution traces including function call sequences, behavioral patterns, tool invocations, and timing characteristics across different workflow execution paths to identify recurring patterns that characterize typical agent workflow behavior. Pattern mining algorithms are applied to these execution traces to extract behavioral sequences, resource utilization patterns, and temporal execution characteristics that enable forecasting models to predict future workflow behavior based on current execution state and historical patterns.

The evaluation system 404 supports training of specialized forecasting models for different types of agent workflows, enabling the system to account for varying behavioral patterns across different implementation frameworks, execution strategies, and resource utilization characteristics. When the evaluation process identifies workflows with distinct behavioral profiles, separate forecasting models are trained for each workflow type to ensure optimal prediction accuracy for specific agent implementations. The trained forecasting models are saved and can be loaded during runtime execution to generate predictive metadata that includes estimates of future work, expected resource utilization patterns, and anticipated workflow execution characteristics.

The integration between the evaluation system 404 and forecasting model training creates a comprehensive pipeline where offline analysis directly enables online optimization capabilities. The behavioral patterns, usage metadata, and performance characteristics extracted during evaluation provide the foundation for forecasting models that generate predictive metadata during runtime execution. This predictive metadata can be attached to inference server requests, enabling intelligent resource allocation decisions, KV cache optimization, and server-side routing based on anticipated future workload rather than point-in-time resource availability, fundamentally transforming how agent workflows interact with inference infrastructure.

The forecasting capabilities integrated into the evaluation system 404 enable continuous learning and model improvement through ground truth feedback mechanisms that update forecasting models based on actual workflow execution outcomes. During production deployment, the system 404 can compare predicted behavior patterns against actual execution results, using this ground truth data to refine forecasting model accuracy and adapt to changing workflow behavior over time. This creates a self-improving system where the evaluation-based training process progressively enhances the quality of predictive metadata generation, enabling increasingly accurate resource allocation decisions and performance optimization strategies for agent workflow deployments.

For example, when a user 108 submits a customer support ticket classification task to an AI agent workflow (e.g., the AI agent workflow 408), the AI agent system 104 first loads the pre-trained forecasting models that were created during offline profiling of similar workflows. As the AI agent workflow begins processing the request, the AI agent system's callback handlers intercept the initial LM call and identify that this request originates from the ticket classification function within the AI agent workflow. Using the loaded Hoeffding Tree forecasters, the AI agent workflow generates predictive metadata that estimates this workflow will require approximately 3-4 additional LM calls over the next 12 seconds, with the next call occurring in roughly 2.3 seconds and expecting to generate around 450 completion tokens. The AI agent workflow also identifies through pattern mining analysis that this request shares a common prompt prefix with 67% of similar classification workflows, indicating high cache optimization potential. This comprehensive predictive metadata package, including expected future calls, timing intervals, token generation estimates, and cache hints, can be automatically attached to the current inference request before being sent to the inference server.

Upon receiving the request with attached predictive metadata, the inference server's routing algorithms can make intelligent allocation decisions that account for anticipated future workload rather than just current resource availability. In this example, the inference server recognizes that despite GPU Worker A appearing less loaded with only 2 current requests, the predictive metadata indicates those requests involve workflows expecting 8-10 additional LM calls each with high token generation requirements. Meanwhile, GPU Worker B has 4 current requests, but the metadata shows these are single-call workflows nearing completion. The inference server routes the new classification request to Worker B, pre-populates the KV cache with the identified common prompt prefix, and selects aggregated serving mode based on the predicted moderate token output. Additionally, the inference server reserves capacity for the 3 anticipated follow-up calls from this workflow, enabling it to maintain consistent low latency even as the agent progresses through its multi-step reasoning process, demonstrating how predictive workload visibility enables fundamentally different resource allocation strategies compared to reactive serving approaches.

In some cases, a ground truth data 420 component provides reference information against which the AI agent workflow 408 output can be compared for accuracy and correctness evaluation. This ground truth data 420 enables traditional evaluation metrics such as accuracy, relevance, and groundedness assessments that complement the performance-focused analysis provided by the instrumentation data 416. The integration of ground truth data 420 with performance metrics creates a comprehensive evaluation approach that addresses both functional correctness and operational efficiency.

A score component 422 represents the final evaluation results that combine insights from the performance analysis and traditional accuracy assessments. This score component 422 may generate standardized reports that include the various metrics produced by the metric generation component 418, providing developers with actionable insights about their agent workflow performance. The score component 422 enables developers to identify optimization opportunities, understand scaling behavior, and make informed decisions about deployment configurations.

For example, the score component 422 serves as the comprehensive reporting engine that synthesizes all performance analysis data into actionable intelligence for developers. Namely, when analyzing a multi-framework agent workflow that uses both LangChain and LlamaIndex components, the score component 422 may generate a detailed performance report showing that the LangChain-based retrieval component contributes 73% of the total workflow latency during concurrent request processing, while the LlamaIndex-based reasoning component maintains consistent sub-second response times across all concurrency levels. These reports may include specific recommendations such as "Consider implementing caching for the retrieval component" or "Current bottleneck at 8 concurrent users suggests infrastructure scaling at this threshold."

The score component 422 may also generate comparative analysis reports that help developers understand how different implementation choices affect performance metrics. For instance, it might produce a report showing that switching from a LangChain-based tool to a CrewAI-based equivalent for the same function reduces average token usage by 23% while maintaining the same accuracy score, or that certain prompt patterns identified across multiple framework boundaries result in 15% higher completion token generation. These insights enable developers to make data-driven decisions about which frameworks and configurations to use for specific components of their agent workflows.

Additionally, the score component 422 may create deployment optimization reports that combine performance efficiency metrics with traditional accuracy assessments to provide holistic recommendations. These reports might indicate that while one configuration achieves 95% accuracy, an alternative approach achieves 92% accuracy but with 40% lower latency and 30% reduced token consumption, enabling developers to make informed trade-offs based on their specific deployment requirements and cost constraints. The standardized format ensures that these insights can be integrated into existing development workflows and decision-making processes across different teams and frameworks.

The evaluation system 404 demonstrates the integration between performance analysis and traditional evaluation approaches, showing how the AI agent system can provide comprehensive insights into both the functional and operational characteristics of agent workflows. The evaluation system 404 enables offline analysis that can simulate multiple concurrency levels and user load patterns while maintaining the standardized data collection and analysis capabilities that work across different agent framework implementations.

The flow from the evaluation dataset 414 through the AI agent workflow 408 to the final score component 422 illustrates the systematic approach that enables developers to obtain reproducible and comparable evaluation results regardless of the complexity or framework diversity of their agent implementations. This evaluation methodology supports the toolkit's goal of providing comprehensive agent analysis capabilities that extend beyond traditional accuracy-focused evaluation to include the performance optimization insights that are important for production deployment of AI agent systems.

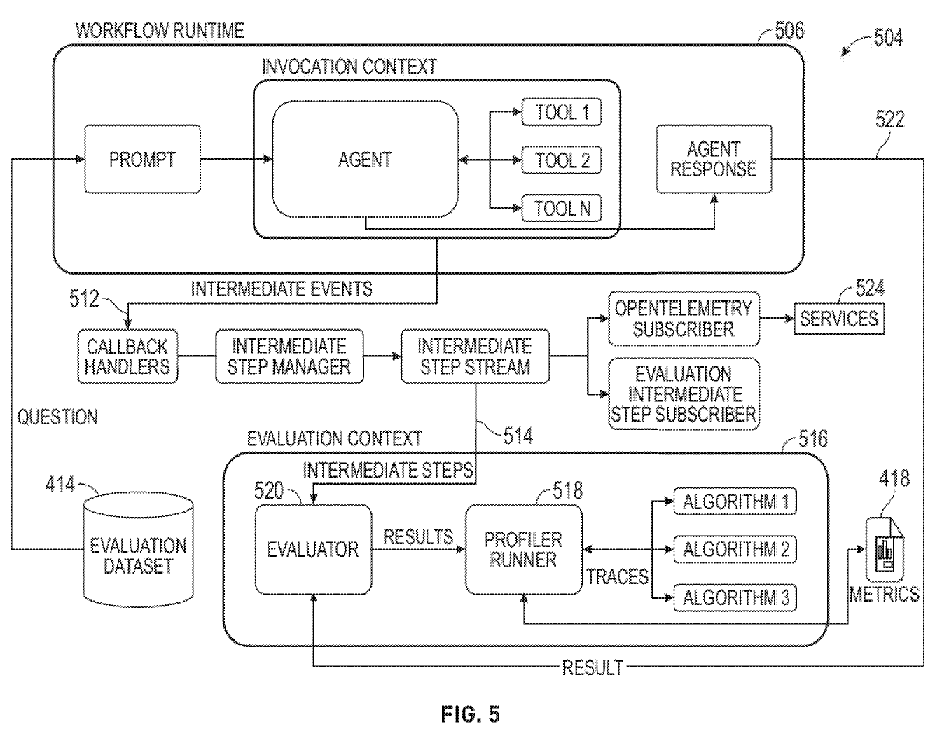

FIG. 5 illustrates an evaluation system 504, according to at least some embodiments of the present disclosure. Specifically, FIG. 5 illustrates the evaluation system 504 that demonstrates the comprehensive instrumentation and analysis capabilities of the AI agent system 104 for profiling and evaluating AI agent workflows during execution. This evaluation system 504 may represent the integration of real-time data collection, standardized event processing, and algorithmic analysis that enables developers to obtain detailed performance insights and behavioral characteristics from their agent implementations. The evaluation system 504 may provide a unified framework for collecting, processing, and analyzing execution data from AI agent workflows 116 regardless of their underlying framework implementations.

The workflow runtime component may serve as the execution environment where AI agent workflows 506 operate and process user requests. This runtime environment may coordinate the execution of various workflow components including agents, tools, and other processing elements while maintaining comprehensive instrumentation capabilities. The workflow runtime may ensure that all execution events are properly captured and made available for analysis through the integrated monitoring and profiling systems. The invocation context within the workflow runtime component may represent the execution environment and state information that surrounds each workflow execution instance. This context may include session data, user information, configuration parameters, and other contextual elements that influence how the AI agent workflow 506 processes requests and generates responses. The invocation context may provide the necessary environmental information that enables proper interpretation and analysis of execution traces and performance data.

The AI agent workflow 506 may represent the target system being analyzed, which can include any combination of agents, tools, LMs, retrievers, and other components implemented across different frameworks. This workflow may execute the core business logic and processing required to handle user queries and generate appropriate responses. The AI agent workflow 506 may be instrumented through the evaluation system 504 to capture comprehensive execution data without requiring modifications to the underlying workflow implementation.

The evaluation dataset 414 may provide reference data and test cases that are used to systematically evaluate workflow performance and behavior of the AI agent workflow 506. This evaluation dataset 414 may include representative inputs, expected outputs, and evaluation criteria that enable consistent and repeatable analysis of workflow implementations. The evaluation dataset 414 may support both automated evaluation processes and manual analysis workflows.

Intermediate events 512 may represent the real-time stream of execution events generated during workflow processing. These intermediate events 512 may include tool invocations, LM calls, data retrieval operations, and other processing steps that occur during workflow execution. The intermediate events 512 may be captured through the instrumentation system and made available for both real-time monitoring and offline analysis purposes.

Services 524 component may represent external or managed services that support the evaluation and analysis process. These services 524 may include observability platforms, data storage systems, analytical processing engines, and other infrastructure components that enable comprehensive workflow analysis. The services 524 may provide scalable processing capabilities that support the evaluation system's analytical requirements.

The callback handlers may implement the instrumentation mechanism that intercepts and captures execution events from the AI agent workflow 506. These handlers may be automatically registered with different framework implementations to ensure comprehensive coverage of workflow execution events. The callback handlers may extract relevant metadata from framework-specific events and convert them into standardized formats that can be processed by the evaluation system 504. The intermediate step manager may coordinate the collection and distribution of execution events from the callback handlers. This manager may receive events from various sources within the workflow execution environment and ensure they are properly formatted and distributed to appropriate subscribers. The intermediate step manager may maintain the integrity and ordering of execution events while supporting multiple concurrent subscribers.

The intermediate step stream may serve as the central data pipeline that distributes standardized execution events to various analysis and monitoring components. This stream may implement a reactive architecture that supports real-time event processing while maintaining historical data for offline analysis. The intermediate step stream may ensure that all execution events are available in a consistent format regardless of their originating framework or component.

An OpenTelemetry subscriber may implement standardized observability data export capabilities that enable integration with external monitoring and visualization platforms. This subscriber may convert the standardized intermediate events into OpenTelemetry-compatible formats that can be consumed by various observability tools and platforms. The OpenTelemetry subscriber may enable cross-platform visibility and monitoring of workflow execution data.

An evaluation intermediate step subscriber may collect execution events specifically for evaluation and analysis purposes. This subscriber may process the intermediate step stream data to prepare it for algorithmic analysis and performance evaluation. The evaluation intermediate step subscriber may filter and aggregate execution events to support the specific requirements of the evaluation algorithms and profiling components.

In some examples, an evaluation context 516 may provide the contextual information and configuration parameters that guide the evaluation process. This context may include evaluation criteria, performance thresholds, analysis parameters, and other settings that determine how execution data should be analyzed and interpreted. The evaluation context 516 may ensure that evaluation results are meaningful and aligned with the specific requirements of the workflow being analyzed.

For example, the evaluation context 516 may contain specific performance threshold parameters such as maximum acceptable latency targets (e.g., "LLM response time must not exceed 2.5 seconds"), concurrency limits for testing (e.g., "evaluate performance at 1, 2, 4, 8, and 16 concurrent users"), and token efficiency benchmarks (e.g., "flag workflows where completion tokens exceed 500 tokens per response"). The context 516 may also specify analysis parameters including which profiling algorithms to apply, such as enabling nested bottleneck analysis for workflows with function call depths greater than 3 levels or activating token pattern analysis for workflows that include retrieval-augmented generation components. Additionally, the evaluation context 516 may define framework-specific settings that determine how different agent implementations should be instrumented and monitored, such as specifying callback handler registration priorities for LangChain versus LlamaIndex components.

The evaluation context 516 may also include workflow-specific configuration parameters that customize the analysis approach based on the type of agent being evaluated. For instance, it may specify that customer service chatbots should be evaluated with emphasis on response time consistency across conversation turns, while code generation agents should prioritize token efficiency and accuracy metrics. The context 516 may define custom evaluation datasets appropriate for different workflow types, establish baseline performance metrics derived from previous evaluation runs, and configure the frequency and scope of profiling data collection. Furthermore, the evaluation context 516 may contain integration settings that determine how evaluation results should be exported to external observability platforms, specify which stakeholders should receive automated performance reports, and define alert thresholds that trigger notifications when performance metrics fall below acceptable ranges.

Intermediate steps 514 may represent the processed and standardized execution data that has been prepared for analysis. These intermediate steps 514 may include normalized representations of tool calls, LM invocations, data retrieval operations, and other workflow execution events. The intermediate steps 514 may maintain temporal ordering and hierarchical relationships that enable comprehensive workflow analysis.

For example, the intermediate steps 514 may contain standardized event data structures that capture specific execution details regardless of the originating framework implementation. When a LangChain-based agent makes an LLM call, the custom callback handlers may extract framework-specific metadata such as langchain.schema.messages.AIMessage objects with nested content fields and timing data in LangChain's proprietary format. Simultaneously, when a LlamaIndex agent performs a similar LLM operation, the callback handlers may capture metadata in LlamaIndex's native format, which could include llama_index.core.base.llms.types.ChatMessage objects with different field structures. The intermediate steps 514 may transform both of these disparate data structures into a unified format that includes standardized fields such as input_text, output_text, prompt_tokens, completion_tokens, latency_ms, timestamp_iso, and function_ancestry, ensuring that LLM calls appear identical regardless of whether they originated from LangChain, LlamaIndex, CrewAI, or any other supported framework.

The intermediate steps 514 may also include hierarchical metadata that maintains complete execution ancestry chains across framework boundaries. For instance, if an agent workflow begins with a LangChain ReAct agent that calls a LlamaIndex retriever tool, which subsequently invokes a CrewAI sub-agent, the intermediate steps 514 may maintain a complete ancestry chain showing how langchain_react_agent.execute() called llamaindex_retriever.search() which then called crewai_specialist.analyze(). Each event in the intermediate steps 514 may contain standardized metadata fields including execution timestamps (e.g., start_time: 2025-01-15T14:30:25.123Z), token utilization metrics (e.g., prompt_tokens: 1247, completion_tokens: 389), performance indicators (e.g., execution_duration_ms: 2340), and unique identifiers that enable downstream analysis algorithms to reconstruct complete workflow execution timelines and identify performance bottlenecks at any level of the execution hierarchy.

Additionally, the intermediate steps 514 may support multiple event types including function start events, function end events, tool invocation events, LLM request events, and retrieval operation events, each with their own specialized metadata fields that capture the specific characteristics relevant to that event type. The temporal ordering preserved within the intermediate steps 514 may enable analysis capabilities such as identifying concurrent execution regions, measuring end-to-end latency across nested function calls, and tracking token efficiency patterns across different stages of agent workflow execution, providing developers with unprecedented visibility into the behavioral characteristics of their multi-framework agent implementations.

An evaluator component 520 may implement the evaluation logic that assesses workflow performance, accuracy, and other behavioral characteristics. This evaluator component 520 may apply various evaluation metrics and algorithms to the collected execution data to generate quantitative assessments of workflow behavior. The evaluator component 520 may support multiple evaluation methodologies and can be configured to assess different aspects of workflow performance.

For example, the evaluator component 520 may implement sophisticated evaluation logic that operates on the standardized intermediate steps 514 and evaluation context 516 to generate comprehensive assessments of agent workflow behavior across multiple dimensions. This evaluator component 520 may apply diverse evaluation methodologies including traditional accuracy metrics such as groundedness and relevance assessments, as well as behavioral performance metrics that analyze workflow efficiency and operational characteristics. For example, the evaluator component 520 may implement algorithms that compare agent outputs against ground truth datasets from the evaluation dataset to calculate precision and recall scores, while simultaneously analyzing the intermediate step data to assess response consistency across different input variations. The evaluator component 520 may support configurable evaluation criteria where developers can specify custom evaluation thresholds, such as requiring accuracy scores above 85% for production deployment or establishing maximum acceptable response times for real-time applications.

The evaluator component 520 may also integrate multiple evaluation algorithms that can operate concurrently on the same execution data to provide comprehensive workflow assessment. For instance, the evaluator component 520 may simultaneously run accuracy evaluation algorithms that compare generated outputs to expected results, relevance evaluation algorithms that assess whether responses appropriately address user queries, and safety evaluation algorithms that detect potentially harmful or inappropriate content. The evaluator component 520 may support domain-specific evaluation methodologies, such as implementing specialized code evaluation algorithms for agent workflows that generate programming solutions, mathematical validation algorithms for agents that solve computational problems, or fact-checking algorithms for agents that provide informational responses. These evaluation algorithms may be dynamically selected based on the workflow type and evaluation context 516 configuration, allowing the same evaluator component 520 to assess diverse agent implementations using appropriate evaluation criteria.

Furthermore, the evaluator component 520 may generate quantitative assessments that combine multiple evaluation metrics into comprehensive scores and detailed evaluation reports. The component 520 may implement weighted scoring systems where different evaluation criteria contribute proportionally to overall workflow assessment scores, enabling developers to emphasize specific performance characteristics such as prioritizing accuracy over speed for research applications or balancing response quality with latency for customer service implementations. The evaluator component 520 may also support comparative evaluation capabilities that assess multiple workflow configurations or agent implementations against the same evaluation dataset, generating detailed comparative analysis reports that highlight performance differences and optimization opportunities across different agent architectures or parameter configurations.

A profiler component 518 may implement specialized analysis algorithms that focus on performance characteristics, bottleneck identification, and resource utilization patterns. This component 518 may analyze execution traces to identify latency issues, concurrency limitations, token usage patterns, and other performance-related insights. The profiler component 518 may generate detailed performance reports including performance efficiency metrics that help developers understand and optimize their workflow implementations. The algorithm components may represent the various analytical algorithms that process execution data to generate insights and performance efficiency metrics. These algorithms may include latency analysis routines, bottleneck detection algorithms, concurrency analysis methods, and token efficiency calculations. The algorithm components may operate on the standardized execution data to produce meaningful performance and behavioral insights.

The traces may represent the structured execution data that has been processed and prepared for algorithmic analysis. These traces may include comprehensive information about workflow execution paths, timing data, resource utilization, and component interactions. The traces may maintain the hierarchical and temporal relationships between execution events that enable detailed workflow analysis.

The metric generation component 418 may collect and aggregate the quantitative measurements and assessments generated by the evaluation and profiling algorithms. This component may calculate summary statistics, trend analysis, and comparative measurements that provide insight into workflow performance and behavior as the performance efficiency metrics. The metric generation component 418 may support both real-time monitoring and historical analysis of workflow characteristics.

For example, the performance efficiency metrics may encompass a comprehensive suite of analytical measurements that provide unprecedented visibility into AI agent workflow behavior across different operational dimensions. The latency analysis metrics may examine LM inference times at granular levels, measuring individual LLM call durations, tool execution latencies, and complete workflow runtime statistics across various concurrency scenarios. For example, when analyzing a multi-agent customer service workflow, the latency analysis metrics might reveal that the initial query classification LLM call averages 1.8 seconds under single-request conditions but degrades to 4.2 seconds when processing 12 concurrent requests, while the downstream knowledge retrieval component maintains consistent sub-second performance regardless of concurrency levels. These metrics may also track end-to-end workflow completion times, identifying scenarios where a workflow that typically completes in 8.5 seconds under normal load extends to 23.7 seconds during peak concurrent usage periods.

Bottleneck analysis metrics may leverage the hierarchical function ancestry tracking capabilities to identify performance degradation points with surgical precision across framework boundaries. By analyzing execution timestamps in conjunction with function call hierarchies, these metrics can isolate bottlenecks to specific nested components within complex multi-framework workflows. For instance, the bottleneck analysis might determine that within a retrieval-augmented generation workflow, 68% of total execution latency stems from a single Pinecone vector database query operation embedded four function calls deep in a LlamaIndex retriever tool that is called by a LangChain parent agent. The metrics may provide a detailed breakdown showing that while the primary reasoning LLM calls complete in an average of 2.1 seconds, the nested vector similarity search operation requires 12.8 seconds, creating a clear optimization target for developers seeking to improve overall workflow performance.

The concurrency analysis metrics may automatically identify execution patterns where agent workflows exhibit natural parallelization opportunities and correlate these with hardware resource utilization during peak concurrent processing periods. These metrics can distinguish between workflow regions that benefit from concurrent execution versus those that create resource contention bottlenecks. Additionally, the token efficiency metrics may generate detailed analyses of prompt token versus completion token utilization patterns, enabling developers to identify optimization opportunities such as prompt compression strategies or response length optimization targets. For example, the token efficiency analysis might reveal that a code generation workflow consistently uses 1,247 prompt tokens to generate an average of 389 completion tokens, but certain prompt patterns result in significantly higher completion token generation, suggesting opportunities for prompt refinement or model parameter adjustments that could reduce both inference costs and latency while maintaining output quality.

A results 522 component may consolidate and present the outcomes of the evaluation and profiling analysis in formats suitable for developer consumption. These results 522 may include performance reports, behavioral insights, optimization recommendations, and comparative analysis across different workflow configurations or implementations. The results 522 may be formatted to support both automated processing and human interpretation.

The evaluation system 504 may coordinate the interaction between all these components to provide a comprehensive analysis framework that operates transparently during workflow execution. The system 504 may automatically discover framework implementations, register appropriate instrumentation handlers, collect and normalize execution data, apply analytical algorithms, and generate actionable insights that help developers understand and optimize their AI agent workflows across different framework implementations and deployment scenarios.

In some examples, the profiler component 518 performs comprehensive behavioral analysis operations that serve as the foundation for training forecasting models (which may be implemented by the profiler component 518) used in online inference optimization. During the offline profiling phase, the profiler component 518 processes the standardized intermediate steps 514 collected from agent workflow executions to extract behavioral patterns, timing characteristics, and resource utilization profiles that characterize how workflows behave across different execution scenarios. This behavioral analysis enables the profiler component 518 to generate usage metadata that captures workflow execution patterns, intervals between consecutive LM calls, expected completion token generation patterns, and resource consumption profiles contextualized to each function within the agent workflow.

The profiler component 518 implements pattern mining algorithms, specifically PrefixSpan, that automatically analyze input prompts from LM requests captured through the intermediate step stream to identify common prompt prefixes across multiple agent workflow executions. The profiler component 518 applies configurable frequency thresholds, such as requiring prefixes to occur across 30-40% of prompts within a given request type to be considered common, though this threshold can be adjusted based on deployment requirements and the scale of request volume. These identified common prefixes are incorporated into the behavioral profile data that will be used to train forecasting models, enabling the inference server to make intelligent KV cache population decisions and pre-populate caches with frequently occurring prompt structures during runtime execution.

During multi-concurrency simulation operations, the profiler component 518 executes agent workflows across multiple concurrency levels while collecting comprehensive execution traces that capture end-to-end workflow execution data including function ancestry information and hierarchical relationships between workflow components. The profiler component 518 simulates user load patterns by varying the number of simultaneous requests processed by the agent workflows, generating standardized invocation traces that enable identification of performance bottlenecks that only become apparent under concurrent load conditions. This multi-concurrency analysis provides the profiler component 518 with statistical distributions of workflow behavior under different load scenarios, creating robust training datasets for forecasting models.

The profiler component 518 performs detailed timing analysis operations that measure LM latency across different parts of agent workflows, calculating end-to-end workflow runtime statistics for each concurrency level and identifying performance bottlenecks by examining execution timestamps and function call durations. For example, during evaluation of a customer support ticket classification workflow, the profiler component 518 may determine that the initial LM call typically takes 2.3 seconds, followed by a tool invocation requiring 1.8 seconds, then a subsequent LM call occurring 4.1 seconds after the tool completion. These timing patterns are captured as training data that enables forecasting models to predict future workflow execution timing during runtime operations.

The profiler component 518 generates comprehensive token efficiency analysis by capturing input token counts and output token counts for each LM invocation within the workflows, recording timestamps and metadata for tool calls and LM calls during execution. The profiler component 518 calculates token efficiency metrics as ratios of prompt tokens versus completion tokens based on standardized data frames, enabling forecasting models to predict expected token generation patterns. For instance, the profiler component 518 may determine that a specific workflow function typically processes 1,247 prompt tokens and generates 389 completion tokens with a latency of 2,340 milliseconds, creating behavioral profiles that forecasting models use to predict similar patterns during runtime execution.

The profiler component 518 tracks function ancestry relationships to identify nested function call hierarchies within the offline profiling data, analyzing timestamps and event types to identify bottleneck locations within nested functions. The profiler component 518 maintains complete execution ancestry chains across framework boundaries, such as when a LangChain ReAct agent calls a LlamaIndex retriever tool, which subsequently invokes a CrewAI sub-agent, preserving hierarchical metadata that shows how functions interconnect. This ancestry tracking enables the profiler component 518 to generate training data that characterizes not just individual function behavior, but also the interaction patterns between functions that forecasting models use to predict complete workflow execution sequences.

The profiler component 518 performs specialized behavioral pattern extraction that serves as training data for Hoeffding Tree forecasting models used during runtime optimization. The profiler component 518 analyzes execution traces including function call sequences and behavior patterns by tracking LM invocations, tool calls, and execution timing patterns across different workflow execution paths. Pattern mining algorithms are applied by the profiler component 518 to identify recurring behavioral sequences, common prompt structures, and resource utilization patterns that characterize agent workflow behavior, generating training datasets that capture statistical distributions of workflow execution characteristics including function ancestry relationships, token usage patterns, and temporal execution sequences.

The profiler component 518 implements workflow-specific analysis capabilities that enable training of specialized forecasting models for different types of agent workflows with varying implementation frameworks, execution patterns, or resource utilization characteristics. For example, when analyzing a financial data analysis workflow versus a code generation workflow, the profiler component 518 identifies distinct behavioral patterns where the financial workflow typically makes 3-4 LM calls with moderate token generation (200-400 completion tokens per call), while the code generation workflow makes 5-7 calls with high token generation (801-1200 completion tokens per call). This workflow-specific analysis enables the profiler component 518 to generate training data for specialized forecasting models tailored to each workflow type.

The profiler component 518 coordinates with the evaluation context 516 to ensure that behavioral analysis occurs across representative evaluation datasets that simulate diverse user load patterns and workflow execution scenarios. The profiler component 518 processes evaluation datasets comprising representative inputs across multiple concurrency levels, analyzing execution traces to extract comprehensive behavioral characteristics that form the basis for training forecasting models. The profiler component 518 generates standardized training datasets from the analyzed function calls and behavior patterns, ensuring that forecasting models receive sufficient training data to predict workflow behavior accurately during runtime execution across different operational conditions.

For example, during analysis of a customer support agent workflow, the profiler component 518 processes 1,000 evaluation requests across concurrency levels of 1, 5, 10, and 20 simultaneous users. The profiler component 518 determines that 67% of requests share a common prompt prefix of 450 tokens containing system prompts and agent instructions. For the primary classification function, the profiler component 518 identifies that it typically makes an initial LM call requiring 1,247 prompt tokens and generating 389 completion tokens with 2.34 seconds latency, followed by a retrieval tool call taking 1.8 seconds, then a final LM call with 1,456 prompt tokens generating 234 completion tokens in 1.9 seconds. The profiler component 518 captures these patterns as training data showing this workflow requires an average of 3.2 LM calls over 6.1 seconds total execution time, with high cache optimization potential due to the 67% prompt prefix commonality. This behavioral profile data enables forecasting models to predict during runtime that when this workflow begins executing, the inference server should expect 2-3 additional requests with similar prompt prefixes occurring within the next 6 seconds, allowing for intelligent routing and cache population decisions.

During runtime execution of AI agent workflows, the profiler component 518 generates predictive metadata through a sophisticated forecasting process that builds upon the offline profiling foundation. When an agent workflow begins processing a request, the AI agent system 104 loads pre-trained forecasting models (e.g., implemented as Hoeffding trees) that were created during the offline profiling phase using historical execution data from similar workflows. As the workflow executes and reaches LM invocation points, the system's callback handlers intercept these calls and analyze the current execution state, including the specific function making the request, the current workflow position, and the input characteristics. The trained forecasting models (e.g., the profiler component 518) then process this contextual information to generate predictive metadata that includes estimates of future work such as the expected number of additional LM calls (typically 3-4 for classification workflows), anticipated completion token generation (ranging from 200-1200 tokens depending on workflow type), expected time intervals between consecutive calls (often 2-6 seconds apart), and resource utilization patterns. This predictive metadata also incorporates cache optimization hints based on common prompt prefixes identified through pattern mining algorithms, where prefixes occurring across 30-40% of similar requests are flagged for potential KV cache population.

The generated predictive metadata is seamlessly attached to inference requests through multiple mechanisms, including embedding within request headers, payload structures, or through specialized communication protocols that maintain compatibility with existing inference server architectures. For example, when a customer support ticket classification workflow makes an initial LM call, the attached metadata might indicate that the server should expect 2-3 additional requests within the next 6 seconds, with moderate token generation requirements and high cache optimization potential due to shared prompt prefixes. Upon receiving requests with this predictive metadata, the inference server's routing algorithms can make intelligent resource allocation decisions that account for anticipated future workload rather than just current resource availability. The server can choose between routing requests to GPU workers with high KV cache matches despite higher current load versus workers with lower cache matches but better immediate availability, select between aggregated and disaggregated serving modes based on predicted output token characteristics, pre-allocate resources for expected follow-up requests, and populate KV caches with identified common prompt prefixes to reduce latency for subsequent calls. This predictive approach enables the inference server to reduce tail latency and optimize resource allocation across concurrent agent workflow executions through coordinated workload management that was previously impossible with reactive serving architectures

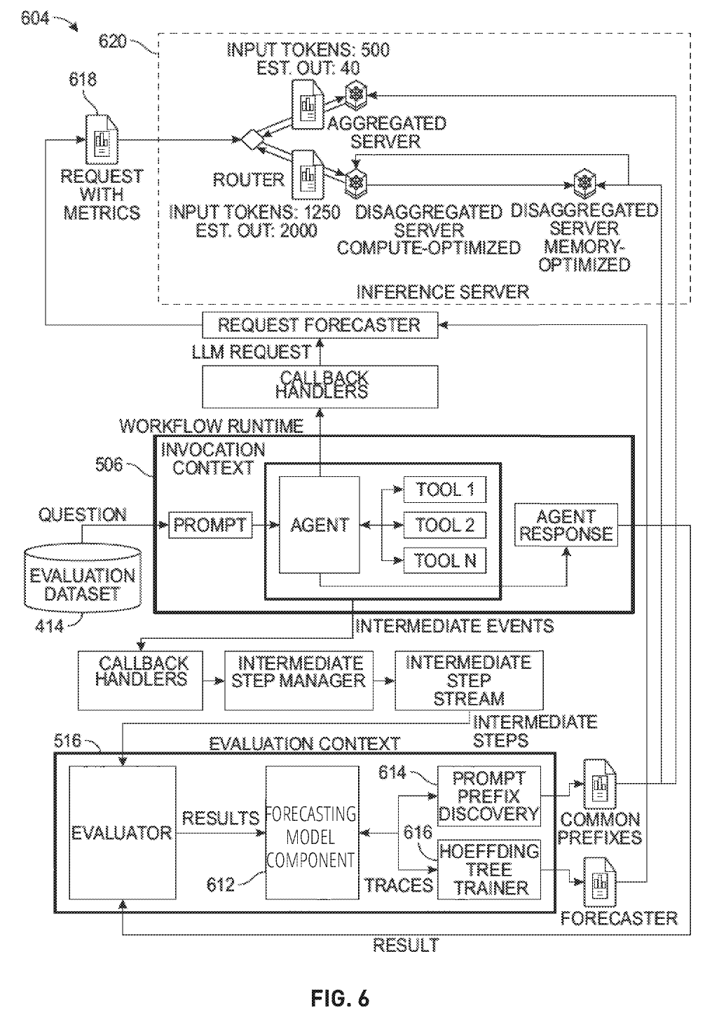

FIG. 6 illustrates a forecasting model system 604, according to at least some embodiments of the present disclosure. Specifically, FIG. 6 illustrates the forecasting model system 604 with forecasting capabilities that demonstrate the comprehensive integration of offline profiling and online predictive optimization for AI agent workflows. FIG. 6 extends the evaluation framework shown in FIG. 5 by incorporating forecasting components that enable the AI agent system 104 to generate predictive metadata for intelligent inference server routing and resource allocation decisions. This forecasting model system 604 represents the core architecture that enables the online profiling by combining behavioral analysis capabilities with predictive modeling to transform how agent workflows interact with inference infrastructure.

The AI agent workflow 506 maintains the same comprehensive instrumentation capabilities as shown in FIG. 5, with an invocation context that includes tools, prompts, agents, and agent responses that are monitored during execution. The callback handlers continue to intercept framework invocations and extract metadata from agent workflow executions, while the intermediate step manager coordinates the collection and distribution of execution events to various analysis components. These foundational components enable the forecasting model system 604 to collect the behavioral data necessary for training forecasting models that predict future workflow behavior patterns.

For example, the AI agent workflow 506 collects comprehensive temporal behavioral data that characterizes the timing patterns and resource consumption profiles of agent executions across different operational scenarios. This includes runtime metadata such as workflow execution durations, inter-call timing intervals between consecutive LM requests, and token generation patterns that specify both input prompt token counts and expected completion token outputs for each LLM invocation. For example, when analyzing a customer support ticket classification workflow, the system might capture that the initial LM call typically requires 1,247 prompt tokens and generates 389 completion tokens with a 2.34-second latency, followed by a tool invocation requiring 1.8 seconds, then a subsequent LM call occurring 4.1 seconds after tool completion with 1,456 prompt tokens generating 234 completion tokens in 1.9 seconds. The system also tracks resource utilization characteristics across multiple concurrency levels, enabling identification of performance patterns that manifest only under concurrent load conditions, such as how token efficiency ratios change when processing 8 concurrent requests versus single-request scenarios.

Beyond timing metrics, the forecasting model system 604 captures detailed structural behavioral data that maps the hierarchical execution patterns and function ancestry relationships within agent workflows. The callback handlers extract comprehensive metadata about tool invocations, retriever operations, and nested function call sequences, maintaining complete execution ancestry chains that show how functions interconnect across framework boundaries. For instance, the forecasting model system 604 can track complex multi-framework execution paths where a LangChain ReAct agent calls a LlamaIndex retriever tool, which subsequently invokes a CrewAI sub-agent, preserving hierarchical metadata that enables forecasting models to predict not just individual function behavior, but complete workflow execution sequences. This structural data also includes behavioral pattern analysis of sequences of LM calls and tool invocations, enabling the system to identify recurring execution patterns such as iterative loops where agents typically perform 3-5 reasoning cycles with predictable timing intervals and resource requirements.

The forecasting model system 604 employs specialized pattern mining algorithms, specifically PrefixSpan, to automatically analyze input prompts from LM requests and identify common prompt prefixes that occur across multiple agent workflow executions. This behavioral data collection applies configurable frequency thresholds, such as requiring prefixes to occur across 30-40% of prompts within a given request type to be considered common, though this threshold can be adjusted based on deployment requirements and request volume scale. The identified common prefixes extend beyond simple system prompts to include longer shared prompt sequences such as agent prompts and instruction templates, maximizing cache optimization opportunities by automatically discovering optimal prefix lengths for KV cache population. For example, in a financial analysis workflow, the system might identify that 67% of requests share a common 450-token prefix containing system prompts and agent instructions, enabling the forecasting models to predict cache optimization potential and inform inference servers about opportunities for pre-populating GPU caches to reduce serving latency.

A training component 616 processes execution traces collected during the offline profiling phase to create the forecasting models used by a forecasting model component 612 during runtime execution. This training component 616 implements machine learning algorithms that analyze behavioral patterns, timing characteristics, and resource utilization profiles extracted from agent workflow executions across multiple concurrency levels. The training component 616 creates specialized forecasting models that can predict future workflow behavior based on current execution state and historical patterns, with the ability to train separate models for different workflow types that have varying implementation frameworks, execution patterns, or resource utilization characteristics.

For example, the training component 616 employs comprehensive multi-concurrency simulation methodologies that execute agent workflows across varying concurrency levels ranging from single-request scenarios to high-load conditions with 10-20 simultaneous users, enabling the extraction of behavioral patterns that manifest only under concurrent processing scenarios. During this training phase, the training component 616 applies pattern mining algorithms, specifically PrefixSpan, to analyze collected intermediate steps and identify common prompt prefixes that occur across 30-40% of workflow executions, though this threshold remains configurable based on deployment requirements and request volume scale. The training process captures comprehensive usage metadata including workflow execution timing, intervals between consecutive LM calls, expected completion token generation patterns, and/or resource consumption profiles contextualized to each function within the agent workflow, creating rich training datasets that characterize statistical distributions of workflow execution characteristics including function ancestry relationships, token usage patterns, and temporal execution sequences.

The training component 616 implements workflow differentiation capabilities that enable the creation of specialized forecasting models tailored to specific agent implementations with distinct behavioral profiles. For example, when training models for a customer support ticket classification workflow versus a financial data analysis workflow, the training component 616 identifies that the customer support workflow typically executes 3-4 LM calls with moderate token generation (200-400 completion tokens per call) and follows predictable reasoning cycles, while the financial analysis workflow requires 5-7 calls with higher token generation (801-1200 completion tokens per call) and exhibits more complex branching patterns based on data analysis requirements. The training component 616 creates separate Hoeffding Tree regressors for each workflow type, where each specialized model learns the unique timing characteristics, resource utilization patterns, and execution sequences specific to its corresponding workflow implementation, enabling more accurate predictions during runtime execution when requests are routed to the appropriate specialized forecasting model based on workflow signatures or execution context.

The training component 616 incorporates continuous learning capabilities through ground truth feedback mechanisms that enable forecasting models to adapt and improve during production deployment using actual workflow execution outcomes. This approach leverages the inherent streaming data learning capabilities of Hoeffding Trees, which can update their predictive accuracy based on real-time execution results where predicted behavioral patterns are compared against actual workflow performance, creating a self-improving system that progressively enhances prediction quality over time. The training component 616 maintains separate learning trajectories for different workflow types, ensuring that model improvements for one workflow implementation (such as enhanced token prediction accuracy for code generation tasks) do not adversely impact forecasting performance for other workflow types (such as customer service chatbot interactions), thereby preserving the specialized nature of each trained model while enabling coordinated learning across the entire forecasting system.

In some cases, the forecasting models are implemented through an iterative supervised learning process that leverages ground truth data collected during both offline profiling and continuous production deployment phases. During the initial training phase, the system executes AI agent workflows using evaluation training data comprising representative inputs across multiple concurrency levels, generating comprehensive execution traces that serve as ground truth examples for supervised learning. The training component 616 applies pattern mining algorithms to these execution traces to extract labeled training examples that capture statistical distributions of workflow execution characteristics including function ancestry relationships, token usage patterns, and temporal execution sequences, creating supervised learning datasets where input features represent workflow state conditions and target labels represent actual observed behavioral outcomes such as number of subsequent LM calls, completion token counts, and execution timing intervals. The Hoeffding Tree regressors are then trained using this supervised learning approach where each tree learns to map workflow execution contexts to predicted future behavior patterns based on the ground truth behavioral outcomes observed in the training data. Importantly, the training component 616 implements continuous iterative learning during production deployment where actual workflow execution outcomes serve as ground truth labels for ongoing supervised learning, enabling the forecasting models to iteratively refine their predictions by comparing their forecasted metadata against actual execution results and update model parameters through supervised learning techniques that minimize prediction error between forecasted estimates and observed ground truth performance characteristics. This iterative supervised learning approach ensures that the forecasting models progressively improve their accuracy over time by continuously incorporating new ground truth data from completed workflow executions, creating a self-improving system that adapts to changing workflow behavior patterns while maintaining the supervised learning foundation that enables reliable prediction of future agent workflow characteristics.

While the disclosed techniques discuss the one or more forecasting models as one or more Hoeffding trees to learn from streaming data during production deployment, the disclosed techniques are not limited to Hoeffding trees alone. The disclosed techniques could implement various other machine learning models suitable for predicting future workflow behavior patterns and resource utilization characteristics. Random Forest Regressors represent ensemble models that could effectively predict future workflow behavior by combining multiple decision trees trained on different aspects of the offline profiling data, handling the multi-dimensional nature of workflow prediction including token usage, timing, and resource requirements while being adaptable for online learning scenarios. Long Short-Term Memory (LSTM) Neural Networks are specifically designed for sequence prediction and can be particularly effective for predicting temporal execution sequences and workflow behavior patterns over time, excelling at learning complex temporal dependencies in agent workflow execution patterns. Support Vector Machine (SVM) Regressors can be configured for regression tasks and adapted for online learning to predict resource utilization characteristics, effectively modeling the complex relationships between workflow state and future resource requirements. Gradient Boosting Regressors build predictions iteratively and can provide excellent performance for predicting expected workflow execution patterns, completion tokens, and timing characteristics while being adaptable for online learning scenarios similar to Hoeffding trees. Whatever forecasting model is selected, the forecasting model may need to be capable of learning from the offline profiling data collected during evaluation, predicting future workflow behavior patterns and resource utilization characteristics, and adapt during production deployment using ground truth feedback, with the specific choice of forecasting model tailored to the particular characteristics of the agent workflows being optimized and the specific prediction requirements of the deployment environment.

In some examples, the forecasting model component 612 implements the runtime application of trained forecasting models, specifically Hoeffding trees, that predict future workflow behavior patterns based on current execution state and historical patterns captured during the evaluation process. This forecasting model component 612 receives current workflow context information from the intermediate step stream and applies the trained models to generate predictions about expected numbers of additional LM calls, anticipated token generation patterns, and timing characteristics. The forecasting model component 612 operates during runtime execution to generate predictive metadata that includes estimates of future work, enabling the system to attach this information to inference requests for intelligent server-side resource allocation decisions.

A prompt prefix discovery component 614 implements pattern mining algorithms, specifically PrefixSpan, that automatically analyze input prompts from LM requests captured through the intermediate step stream to identify common prompt prefixes across multiple agent workflow executions. The identified common prefixes are incorporated into the predictive metadata that gets attached to inference requests, enabling an inference server 620 to make intelligent KV cache population decisions and pre-populate caches with frequently occurring prompt structures.

A request with predictive metadata 618 represents the enhanced inference requests that include forecasted information about future work, generated by the forecasting model component 612 and attached to LM requests before they are sent to the inference server 620. This predictive metadata includes estimates such as expected numbers of additional requests, anticipated resource utilization patterns, temporal execution sequences, and cache optimization hints based on identified common prompt prefixes. The request with predictive metadata 618 enables the inference server 620 to make intelligent routing decisions based on predicted future workload rather than point-in-time resource availability, fundamentally transforming how agent-server communication occurs in production deployments.

The inference server 620 represents the server-side infrastructure that receives requests with predictive metadata and utilizes this information to make intelligent resource allocation decisions that account for anticipated future workload rather than just current resource availability. The inference server 620 includes multiple server types including aggregated servers and disaggregated servers (both compute-optimized and memory-optimized), with routing capabilities that can evaluate different server options based on predicted token generation patterns, select GPU workers based on expected resource requirements and KV cache optimization opportunities, and pre-allocate resources for anticipated follow-up requests. This predictive approach enables the inference server 620 to reduce tail latency and optimize resource utilization across concurrent agent workflow executions through coordinated workload management that was previously impossible with reactive serving architectures.

For example, when a customer support agent receives a ticket classification request asking "Is my team currently working on any issues related to the latest Acme Corp customer issue?", the forecasting model component 612 generates predictive metadata based on the trained Hoeffding tree models. The forecasting model system 604 predicts this classification workflow will require 3-4 additional LM calls over the next 6.1 seconds, with the first follow-up call occurring in approximately 2.3 seconds and generating around 389 completion tokens, followed by a tool invocation requiring 1.8 seconds, then a final LM call with 1,456 prompt tokens generating 234 completion tokens. The prompt prefix discovery component 614 identifies that 67% of similar classification requests share a common 450-token prefix containing system prompts and agent instructions, indicating high cache optimization potential. This comprehensive predictive metadata package is attached to the request with predictive metadata 618 and sent to the inference server 620, which uses this information to route the request to GPU Worker B despite it having 4 current requests, because the metadata shows these are single-call workflows nearing completion, while GPU Worker A's 2 current requests involve workflows expecting 8-10 additional calls each with high token generation requirements.

For a financial data analysis request requiring complex multi-step reasoning and data processing, the forecasting model component 612 predicts a significantly different behavioral pattern, estimating 5-7 LM calls with higher token generation (801-1,200 completion tokens per call) and more complex branching patterns based on data analysis requirements. The system generates predictive metadata indicating an expected total execution time of 12-15 seconds with irregular timing intervals between calls due to data processing dependencies. The prompt prefix discovery component 614 finds that only 35% of financial analysis requests share common prefixes due to the diverse nature of financial queries, resulting in lower cache optimization potential. The inference server 620 receives this predictive metadata and makes intelligent routing decisions by selecting aggregated serving mode for the high token output characteristics, routing to a GPU worker with high memory capacity, and pre-allocating resources for the predicted 5-7 sequential calls, enabling the server to maintain consistent performance even as the workflow progresses through its computationally intensive analysis phases.

When processing a code generation request for developing a Python function, the forecasting model component 612 predicts a pattern of 4-5 LM calls with very high token generation (1,500-2,000 completion tokens per call) and specific timing characteristics where calls occur in bursts followed by longer processing intervals. The prompt prefix discovery component 614 identifies that 58% of code generation requests share common prefixes related to programming language specifications and coding standards, enabling moderate cache optimization opportunities. The inference server 620 utilizes this predictive metadata to make resource allocation decisions, choosing disaggregated serving mode to optimize for the high token output, pre-populating KV caches with the identified coding-related prompt prefixes, and routing to GPU Worker C, which has optimal memory-to-compute ratios for sustained high-throughput generation tasks, while also reserving capacity for the predicted burst pattern of follow-up requests, demonstrating how predictive workload visibility enables coordinated resource management that anticipates and accommodates the specific computational demands of different workflow types.

Specifically, the AI agent system 104 can identify a customer support ticket classification workflow (first AI agent workflow) implemented using LangChain that typically follows a pattern of 3-4 LM calls with moderate token generation (200-400 completion tokens per call), and a financial data analysis workflow (second AI agent workflow) implemented using LlamaIndex that exhibits a different pattern of 5-7 LM calls with higher token generation (801-1,200 completion tokens per call) and more complex branching based on data analysis requirements. During offline profiling, the system trains a first specialized Hoeffding tree forecasting model using execution traces from the customer support workflow, capturing its characteristic timing patterns, moderate token usage, and predictable reasoning cycles. Simultaneously, the system trains a second specialized Hoeffding tree forecasting model using execution traces from the financial analysis workflow, learning its unique resource-intensive patterns, longer execution sequences, and variable branching behavior based on analytical complexity.

When a new request arrives asking "Analyze Q3 financial performance trends for emerging markets," the system determines this request is associated with the financial data analysis workflow based on workflow signatures including financial terminology, analytical request characteristics, and execution context indicators. The system loads the second forecasting model and generates predictive metadata indicating an expected 6 LM calls over approximately 12-15 seconds with high token generation requirements (average 950 completion tokens per call). Conversely, when a request arrives asking "Classify this customer complaint about delayed shipping," the system determines this request is associated with the customer support workflow based on the support-related terminology and problem classification characteristics. The system applies the first forecasting model to generate predictive metadata indicating an expected 3 LM calls over approximately 6 seconds with moderate token generation (average 320 completion tokens per call). This workflow-specific approach enables the inference server 620 to make intelligent routing decisions tailored to each workflow type, such as routing the financial analysis request to a GPU worker optimized for sustained high-throughput generation while routing the customer support request to a worker optimized for quick turnaround with lower resource requirements.

The evaluation dataset 414 provides the foundation for training forecasting models by supplying representative inputs that simulate diverse user load patterns and workflow execution scenarios. The evaluation context 516 processes these inputs through agent workflows while the system collects comprehensive execution traces that capture behavioral patterns, token usage characteristics, and timing information. This evaluation process generates the training data necessary for the training component 616 to create accurate forecasting models that can predict workflow behavior during runtime execution.

The profiler component 518 analyzes collected execution traces to extract behavioral patterns and usage metadata that characterizes how workflows behave across different execution scenarios. This profiler component 518 performs timing analysis operations that measure LM latency across different parts of agent workflows, calculates end-to-end workflow runtime statistics, and identifies performance patterns that enable forecasting models to predict future execution characteristics. The profiler component 518 generates statistical distributions of workflow behavior under different load scenarios, creating robust training datasets for forecasting model development.

The intermediate step stream continues to serve as the central data pipeline that distributes standardized execution events to various analysis and forecasting components. During runtime execution, the intermediate step stream enables the forecasting model component 612 to access current workflow state information and execution context that allows forecasting models to generate accurate predictions about future behavior. The stream maintains event ordering and hierarchy relationships across framework boundaries, enabling forecasting models to understand the current position within agent workflow execution sequences.

The forecasting capabilities shown in FIG. 6 enable continuous learning and model improvement through ground truth feedback mechanisms that update forecasting models based on actual workflow execution outcomes. During production deployment, the system can compare predicted behavior patterns against actual execution results, using this feedback to refine forecasting model accuracy and adapt to changing workflow behavior over time. This creates a self-improving system where the evaluation-based training process progressively enhances the quality of predictive metadata generation and optimization strategies.

The comprehensive architecture demonstrated in FIG. 6 represents a fundamental advancement over reactive serving approaches by enabling coordinated optimization based on predicted future work requirements. The system maintains framework-agnostic capabilities that work across heterogeneous agent implementations while providing predictive insights that enable inference servers to make intelligent routing decisions based on anticipated workload characteristics rather than instantaneous resource utilization snapshots. This holistic approach enables optimization strategies ranging from KV cache population and serving mode selection to worker capacity pre-allocation and prompt prefix caching that were previously impossible with traditional reactive serving architectures.

The results generated by this integrated evaluation and forecasting system provide developers with comprehensive insights into both current performance characteristics and predicted future behavior patterns of their agent workflows. The system outputs performance efficiency metrics, behavioral insights, forecasting model accuracy assessments, and optimization recommendations that help developers understand how their agents behave under various operational conditions while enabling intelligent deployment strategies based on predicted workload patterns. This comprehensive approach transforms agent workflow deployment from reactive resource management to proactive optimization based on anticipated behavior patterns and resource requirements.

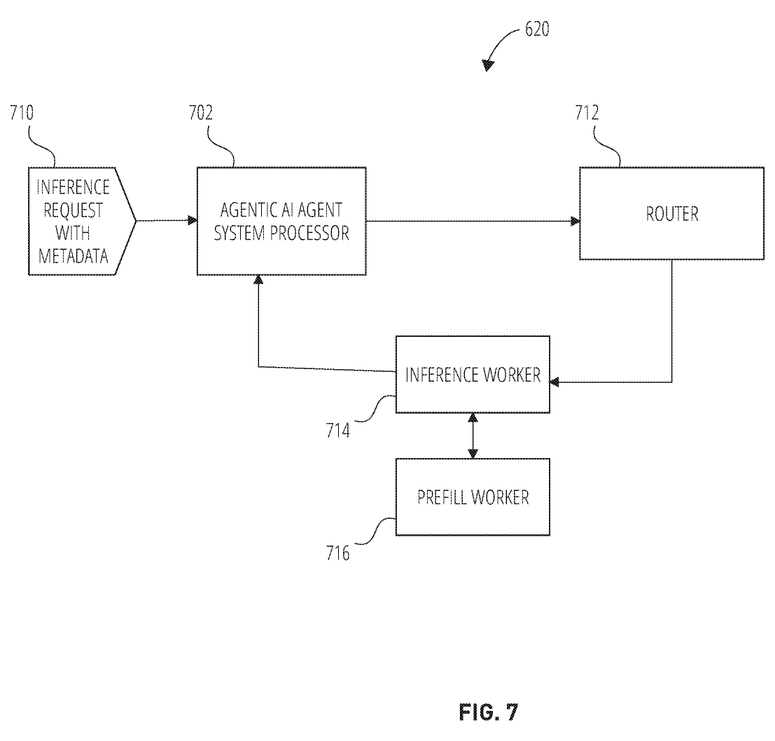

FIG. 7 illustrates an inference server 620, according to at least some embodiments of the present disclosure. Specifically, FIG. 7 illustrates an inference server 620 architecture that may enable intelligent workload-aware routing and resource allocation for one or more AI agent workflows. In some examples, the diagram shown in FIG. 7 may show the operational flow between various components that can work together to process inference requests enriched with predictive metadata from AI agent workflows.

In certain implementations, the inference server 620 architecture may center around an agentic AI agent system processor 702 that can receive and process inference requests containing valuable metadata about future workload characteristics from one or more AI agent workflows. In some cases, this agentic AI agent system processor 702 may serve as the central coordination point for managing how such inference requests flow through the system and how resources (e.g., inference workers and/or KV cache) are allocated based on both current conditions and anticipated future demands.

In some examples, an inference request with metadata 710 may arrive at the agentic AI agent system processor 702 from one or more AI agent workflows containing structured information that can provide insights into expected future workload patterns. In certain cases, this inference request with metadata 710 may include predictive information such as anticipated numbers of reflection iterations, expected token generation requirements for each iteration, reflection prefix patterns that could be used for cache optimization, and/or timing estimates for subsequent requests that may follow in the AI agent workflows.

In certain implementations, the metadata embedded within inference request with metadata 710 may enable the agentic AI agent system processor 702 to make informed decisions about resource allocation that extend beyond traditional point-in-time assessments. In some examples, this metadata may include any combination of estimates of how many additional LM calls are expected, anticipated completion token counts for future requests, expected time intervals between consecutive calls, and/or KV cache optimization hints based on common prompt prefixes that have been identified through pattern analysis.

In some cases, the agentic AI agent system processor 702 may access current operational data including load patterns across the system and KV cache utilization statistics from multiple inference workers 714. In certain examples, the agentic AI agent system processor 702 may simultaneously consider both present system conditions and future expectations encoded or otherwise included in the metadata to make routing decisions that can account for anticipated workload bursts and resource requirements.

In certain implementations, router 712 may receive routing instructions and metadata from agentic AI agent system processor 702 to make intelligent allocation decisions about where to send inference requests. In some examples, router 712 may implement advanced models designed for workload-aware routing decisions that can calculate reward functions for each available inference worker based on both current load patterns and future workload characteristics embedded in the metadata.

For example, router 712 may employ a Thompson sampling process as the mathematical foundation for routing decisions. In certain examples, router 712 may train bandit algorithms using feature vectors that capture current load metrics across all available inference workers 714, and the router 712 may generate reward functions that guide decision-making processes through matrix multiplications. In certain implementations, router 712 may generate comprehensive feature vectors that incorporate multiple factors including current KV cache match levels, current inference worker load metrics, committed future request counts for each worker, and/or estimated timing parameters such as inter-request intervals and output generation times. In some examples, router 712 may calculate opportunity costs for switching between inference workers versus maintaining current assignments using these feature vectors.

In some cases, router 712 may perform matrix multiplications on feature vectors to generate reward estimates for each available inference worker, while Thompson sampling reward functions may continuously update based on actual latency feedback from completed inference requests. In certain examples, router 712 may select optimal subsets of inference workers by comparing exploration versus exploitation tradeoffs using these reward functions.

As an example, the router 712 may construct feature vectors with specific numerical dimensions and values that capture the operational state of the inference infrastructure. For example, router 712 may generate a feature vector [0.73, 4, 7, 2.3, 450] for Worker A, where 0.73 represents the current KV cache match level (73% cache hit probability), 4 indicates the current number of active requests, 7 represents committed future request counts, 2.3 denotes the estimated average inter-request interval in seconds, and 450 represents the expected average output generation time in milliseconds. In some cases, router 712 may simultaneously maintain feature vectors for multiple workers, such as [0.45, 6, 3, 1.8, 320] for Worker B and [0.89, 2, 12, 4.1, 780] for Worker C, enabling comparative analysis across the available inference worker pool.

Namely, router 712 may perform matrix multiplications using learned weight matrices to transform these feature vectors into reward estimates through computational operations. In certain implementations, router 712 may maintain a 5×3 weight matrix W = where each column corresponds to a different worker's learned parameters. When router 712 multiplies the feature vectors, such as the feature vector [0.73, 4, 7, 2.3, 450] for Worker A, with this weight matrix, the resulting reward vector [2.34, 1.67, 3.12] may represent the estimated reward values for Workers A, B, and C respectively, where higher values indicate more favorable routing decisions based on current system state and predicted future workload characteristics.

In certain implementations, router 712 may perform the matrix multiplication by taking each worker's feature vector and multiplying it with the learned weight matrix W to produce individual reward estimates. For Worker A with feature vector [0.73, 4, 7, 2.3, 450], router 712 may calculate the reward estimate as follows: Reward_A = (0.73 × 0.8) + (4 × 0.3) + (7 × -0.4) + (2.3 × 0.2) + (450 × 0.1) = 0.584 + 1.2 + (-2.8) + 0.46 + 45 = 44.444. Similarly, for Worker B with feature vector [0.45, 6, 3, 1.8, 320], router 712 may compute: Reward_B = (0.45 × -0.2) + (6 × 0.6) + (3 × 0.5) + (1.8 × -0.3) + (320 × 0.4) = -0.09 + 3.6 + 1.5 + (-0.54) + 128 = 132.47. For Worker C with feature vector [0.89, 2, 12, 4.1, 780], router 712 may calculate: Reward_C = (0.89 × 0.15) + (2 × -0.1) + (12 × 0.7) + (4.1 × 0.9) + (780 × -0.2) = 0.1335 + (-0.2) + 8.4 + 3.69 + (-156) = -143.9765. In some cases, these calculations may demonstrate how router 712 transforms the multi-dimensional feature space into scalar reward values that can be directly compared for routing decisions. In certain examples, the resulting reward estimates show that Worker B yields the highest reward (132.47), followed by Worker A (44.444), while Worker C produces a negative reward (-143.9765), indicating that routing to Worker C may be unfavorable under the current system conditions and predicted future workload characteristics. In some implementations, router 712 may use these computed reward values to inform the Thompson sampling process, where higher rewards indicate more favorable routing decisions based on the learned weight parameters that have been updated through continuous feedback from actual latency measurements.

The router 712 may calculate opportunity costs by comparing the immediate routing decision against alternative worker assignments using quantitative metrics. For instance, router 712 may determine that routing to Worker A yields an immediate reward of 2.34 but requires 127ms of additional prefill time due to lower KV cache match, while Worker C offers a higher reward of 3.12 but currently handles 12 committed future requests that may create queueing delays averaging 890ms. In some implementations, router 712 may compute the opportunity cost as |3.12 - 2.34| + (890 - 127)/1000 = 0.78 + 0.763 = 1.543, representing the normalized cost differential between these routing choices, where values above 1.0 may indicate significant opportunity costs that influence the exploration versus exploitation decision-making process.

In some cases, router 712 may implement Thompson sampling by maintaining posterior distributions that update based on actual performance feedback from completed requests. In certain implementations, when router 712 receives latency feedback indicating that Worker A completed the request in 1.89 seconds compared to the predicted 2.3 seconds, the agentic AI agent system processor 702 may update the corresponding bandit arm parameters using the reward difference of (2.3 - 1.89)/2.3 = 0.178, adjusting the mean and variance parameters of Worker A's reward distribution accordingly. In some examples, router 712 may use this updated distribution to sample new reward estimates during subsequent routing decisions, where Worker A's updated parameters might shift from a prior mean of 2.34 to 2.51, influencing future Thompson sampling draws and gradually improving the accuracy of routing decisions through this continuous learning mechanism that balances exploration of uncertain workers against exploitation of workers with proven performance characteristics.

In certain implementations, router 712 may monitor current KV cache utilization across multiple inference workers 714 and analyze prompt prefix patterns to identify KV cache optimization opportunities. In some examples, router 712 may calculate KV cache hit probabilities for different worker assignments based on identified prompt patterns and generate cache affinity scores that inform routing decisions. The inference worker 714 may serve as one of multiple processing units that can handle inference requests routed by router 712. In certain examples, inference worker 714 may maintain KV cache storage that can be leveraged to reduce computation requirements for requests that share common prompt prefixes or processing patterns with previously handled requests. In certain implementations, inference worker 714 may receive proactive loading recommendations from router 712 based on predictive metadata analysis. In some examples, these recommendations may enable inference worker 714 to pre-populate KV cache with identified common prompt prefixes, potentially reducing latency for subsequent requests that are anticipated based on the workflow metadata.

For example, the router 712 may continuously monitor KV cache utilization across multiple inference workers 714 by tracking cache hit rates, cache occupancy levels, and prompt prefix frequency distributions in real-time. For example, router 712 may observe that Worker A maintains a KV cache with 78% occupancy containing 450-token prompt prefixes that occur in 67% of financial analysis workflows, while Worker B operates at 45% cache occupancy with 280-token prefixes appearing in 34% of customer support classification requests. In some cases, router 712 may detect that Worker C has recently processed prompts containing common system instructions and agent frameworks, resulting in cached key-value pairs that match 89% of incoming code generation requests, compared to Worker A's 23% match rate for the same request type. This real-time monitoring enables router 712 to maintain comprehensive visibility into cache optimization opportunities across the distributed inference infrastructure.

In some examples, router 712 may calculate KV cache hit probabilities for different worker assignments by applying pattern mining algorithms, specifically PrefixSpan, to analyze prompt structures and identify recurring sequences that occur across 30-40% of workflow executions within specific request categories. For instance, when router 712 receives a customer support classification request beginning with "Analyze the following customer complaint about shipping delays," it may calculate that routing to Worker A yields a 0.73 cache hit probability based on the 450-token common prefix previously cached from similar support workflows, while routing to Worker B provides only a 0.34 probability due to its focus on financial analysis prompts. In certain cases, router 712 may determine that Worker C offers a 0.91 cache hit probability for code generation requests containing programming language specifications and coding standards that match 58% of previously processed development workflows. These probability calculations enable router 712 to quantify the expected cache performance for each routing decision based on historical prompt pattern analysis.

In certain implementations, router 712 may generate cache affinity scores by combining KV cache hit probabilities with current worker load metrics and anticipated future request patterns to create composite routing scores. For example, router 712 may compute an affinity score of 2.84 for Worker A by weighting its 0.73 cache hit probability against its current load of 4 active requests and 7 committed future requests, while Worker C receives a score of 3.47 based on its 0.91 cache hit probability offset by its higher load of 12 committed future requests. In some cases, router 712 may apply temporal weighting factors to these scores, where recent cache hits within the last 2.3 seconds receive higher weight coefficients (1.2x) compared to older cache entries, enabling the router 712 to prioritize workers with fresh, relevant cached content over those with stale but technically matching cache entries. These cache affinity scores inform routing decisions by providing a unified metric that balances immediate cache optimization benefits against predicted future workload characteristics and current system load conditions.

For example, the router 712 may dynamically select subsets of inference workers 714 based on cache affinity scores that evolve continuously as workflow conditions change across different agent execution patterns. For example, when processing a mixed workload containing both customer support classification requests and financial analysis workflows, router 712 may initially maintain a selected subset consisting of Workers A, B, and C based on their respective cache affinity scores of 2.84, 1.67, and 3.47. In some cases, as new requests arrive from one or more AI agent workflows and existing AI agent workflows progress through their predicted execution phases, router 712 may recalculate these scores in real-time, discovering that Worker B's affinity score has increased to 2.95 due to reduced committed future requests (from 6 to 2 active requests), while Worker C's score has decreased to 2.91 as it accumulates additional committed future requests (increasing from 12 to 18 predicted requests over the next 8.5 seconds). In certain examples, this dynamic recalculation may cause router 712 to adjust its selected subset by replacing Worker A (score now 2.34) with Worker B (score now 2.95), demonstrating how the system continuously optimizes worker selection based on evolving workload characteristics and cache utilization patterns.

In some implementations, router 712 may deliberately select slower inference workers over faster ones when cache affinity scores indicate superior long-term performance characteristics despite immediate processing power disadvantages. For instance, when router 712 evaluates routing a customer support request that is part of a predicted 4-request workflow sequence indicated in the inference request with metadata 710, it may encounter Worker D with high processing capabilities (2.1 TFLOPS) but only a 0.34 KV cache hit probability, compared to Worker E with lower processing power (1.6 TFLOPS) but a 0.89 cache hit probability for the anticipated prompt prefix pattern. In certain cases, router 712 may calculate that Worker D would complete the initial request in 1.2 seconds but require extensive prefill operations (450ms each) for the three predicted follow-up requests, resulting in a total projected workflow latency of 4.55 seconds. In some examples, Worker E may require 1.8 seconds for the initial request due to lower processing power, but its high cache hit probability enables subsequent requests to complete in 0.7 seconds each with minimal prefill overhead, achieving a total workflow latency of 3.9 seconds. Through this analysis, router 712 may select the slower Worker E over the faster Worker D, demonstrating how cache affinity considerations and future workload predictions can override immediate processing power advantages in routing decisions.

In certain implementations, router 712 may apply temporal weighting factors and load balancing considerations that further refine worker selection as system conditions fluctuate during peak and off-peak usage periods. In some examples, router 712 may monitor system-wide utilization patterns and detect that during high-concurrency periods (above 12 concurrent requests), cache affinity becomes more critical than raw processing power due to memory bandwidth limitations, causing the system to favor workers with higher cache hit probabilities even if they have 15-20% lower computational throughput. In certain cases, router 712 may implement adaptive threshold adjustments where cache affinity score weightings increase from 0.7x to 1.3x during periods when average queue lengths exceed 5 requests per worker, enabling the system to prioritize cache efficiency over immediate availability. In some implementations, this adaptive approach may result in router 712 dynamically shifting its selected worker subset from performance-optimized workers (Workers A, D) to cache-optimized workers (Workers B, E) as system load increases, while simultaneously adjusting back to performance-optimized selections during low-concurrency periods when cache pressure is reduced and immediate processing speed becomes the dominant performance factor. Workers A, B, C, D and so forth represent individual ones of the inference workers 714.

In some cases, inference worker 714 may process requests that are part of self-reflection workflows where multiple related requests share common processing patterns and cache-friendly prompt structures. In certain examples, inference worker 714 may benefit from the metadata-driven routing decisions that account for future workload characteristics, enabling more efficient resource utilization across sequential requests.

In certain implementations, prefill worker 716 may handle the initial processing and tokenization phases of inference requests before they are processed by inference worker 714. In some examples, prefill worker 716 may work in coordination with the metadata-driven routing system to prepare requests in ways that can take advantage of anticipated cache hits and resource allocation patterns. The prefill worker 716 may receive guidance from router 712 about expected future requests that may follow the current request being processed. In certain examples, this information may enable prefill worker 716 to make decisions about resource allocation and cache preparation that account for anticipated workload patterns rather than just immediate processing requirements.

For example, the prefill worker 716 may handle the initial processing and tokenization phases of inference requests before they are processed by inference worker 714. For example, when agentic AI agent system processor 702 receives an inference request with metadata 710 containing a customer support classification query "Analyze this shipping delay complaint and provide resolution options," prefill worker 716 may perform the initial tokenization process, converting the raw text into 1,247 input tokens while simultaneously analyzing the attached predictive metadata that indicates this workflow will likely generate 3-4 additional related requests over the next 6.1 seconds. In some cases, prefill worker 716 may identify that the current request shares a common 450-token prefix with 67% of similar classification workflows, enabling it to prepare for efficient KV cache utilization across the anticipated sequence of related requests.

In some examples, prefill worker 716 may work in coordination with the metadata-driven routing system to prepare requests in ways that can take advantage of anticipated cache hits and resource allocation patterns. For instance, when router 712 determines through Thompson sampling analysis that Worker B offers a cache affinity score of 2.95 based on current load patterns and predictive metadata, prefill worker 716 may pre-populate specific cache segments with the identified 450-token common prefix before the primary inference processing begins. In certain cases, prefill worker 716 may coordinate with router 712 to prepare multiple cache configurations simultaneously, such as pre-loading the primary 450-token prefix for the current request while also preparing cache space for the anticipated follow-up requests that are predicted to arrive within 2.3-second intervals. This coordinated preparation may enable prefill worker 716 to reduce the effective prefill latency from 450ms to approximately 127ms for subsequent requests in the workflow sequence by leveraging the pre-populated cache structures.

In certain implementations, prefill worker 716 may receive detailed guidance from router 712 about expected future requests that may follow the current request being processed, enabling sophisticated resource preparation strategies. For example, when router 712 processes predictive metadata indicating that a financial analysis workflow will require 5-7 LM calls with high token generation (801-1,200 completion tokens per call) over a predicted 12-15 second execution window, router 712 may transmit specific preparation instructions to prefill worker 716 including cache allocation recommendations, memory pre-allocation requirements, and optimal tokenization strategies for the anticipated request sequence. In some cases, prefill worker 716 may receive guidance indicating that Worker C should be prepared for sustained high-throughput generation tasks, prompting prefill worker 716 to configure memory-to-compute ratios optimally and reserve capacity for the predicted burst pattern of follow-up requests. This guidance may include specific metrics such as expected inter-request intervals of 4.1 seconds, anticipated completion token ranges of 950 tokens per call, and cache optimization opportunities based on 35% common prefix occurrence rates identified through pattern mining algorithms.

In certain examples, this predictive information may enable prefill worker 716 to make decisions about resource allocation and cache preparation that account for anticipated workload patterns rather than just immediate processing requirements. For instance, when processing a code generation request that router 712 predicts will follow a pattern of 4-5 LM calls with very high token generation (1,500-2,000 completion tokens per call), prefill worker 716 may allocate additional memory buffers proactively, configure tokenization parameters for sustained high-throughput output, and prepare KV cache structures to accommodate the predicted 58% common prefix patterns related to programming language specifications and coding standards. In some implementations, prefill worker 716 may make resource allocation decisions such as reserving 2.8GB of GPU memory for the anticipated workflow sequence, configuring batch processing parameters to handle the predicted burst pattern of requests occurring in sequential intervals, and pre-loading specialized tokenization models optimized for code generation tasks based on the workflow type identification provided in the predictive metadata. This forward-looking approach may enable prefill worker 716 to reduce total workflow latency from a predicted 6.2 seconds to an optimized 3.9 seconds by eliminating redundant preparation steps and maintaining optimal cache utilization across the complete anticipated request sequence.

Specifically, agentic AI agent system processor 702 may analyze request concurrency levels to determine resource allocation strategies and calculate expected GPU memory requirements based on both current load patterns and future workload characteristics encoded in the metadata. In certain examples, the processor may continuously balance current load patterns against predicted future demand from AI agent workflows.

In some examples, instead of or in addition to Thompson sampling approaches described above, the agentic AI agent system processor 702 may formulate resource allocation as a comprehensive optimization problem that can be solved using dedicated optimization solvers implemented by one of the inference workers 714 and/or through a specialized dedicated processor component. In certain cases, the agentic AI agent system processor 702 may continuously balance current load patterns against predicted future demand from AI agent workflows using mathematical optimization frameworks that extend beyond sampling-based approaches.

In some implementations, the optimization problem may be formulated as a multi-objective optimization challenge where agentic AI agent system processor 702 seeks to minimize total latency across anticipated request sequences while maximizing KV cache utilization efficiency and balancing workload distribution among available inference workers 714. In certain examples, the optimization solver may implement linear programming techniques where the decision variables represent routing assignments for current and predicted future requests, with constraints including GPU memory limitations, maximum queue lengths per worker, and KV cache capacity restrictions. In some cases, the objective function may incorporate weighted terms for immediate latency reduction, anticipated cache hit probabilities based on prompt prefix patterns identified through pattern mining algorithms, and load balancing penalties that prevent resource concentration on individual workers.

In certain embodiments, the dedicated optimization processor may implement integer programming solvers that can handle discrete routing decisions where each inference request is assigned to one inference worker 714 from the available pool. In some examples, the optimization formulation may include binary decision variables representing whether a specific request-worker pairing is selected, with constraints ensuring that total anticipated GPU memory requirements across all assigned requests do not exceed worker capacity limits. In some cases, the solver may incorporate mixed-integer programming approaches that simultaneously optimize continuous variables such as expected completion times and discrete variables such as worker assignments, enabling more sophisticated resource allocation strategies that account for both immediate and anticipated workload characteristics.

The optimization problem solver may implement quadratic programming techniques to handle non-linear relationships between KV cache affinity scores and routing decisions, where cache utilization benefits exhibit diminishing returns as cache occupancy increases. In certain examples, the agentic AI agent system processor 702 may formulate the optimization challenge as a dynamic programming problem that considers sequential decision-making across multiple anticipated request arrivals, enabling the system to make current routing decisions that optimize for long-term performance across the complete predicted workflow sequence. In some cases, the optimization framework may incorporate stochastic programming approaches that account for uncertainty in predicted future workload characteristics, using probability distributions around anticipated request timing intervals and token generation estimates to create robust routing solutions.

In certain implementations, the dedicated optimization solver may be implemented using specialized mathematical optimization libraries such as CPLEX, Gurobi, or CVXPY that can efficiently handle large-scale optimization problems with hundreds of decision variables representing different routing combinations across multiple inference workers 714 and anticipated request sequences. In some examples, the optimization process may operate in real-time with millisecond-level solution times by employing heuristic optimization algorithms such as genetic algorithms, simulated annealing, or particle swarm optimization that can quickly identify near-optimal routing solutions when exact optimization approaches become computationally prohibitive. In some cases, the optimization solver may implement parallel computing approaches where multiple optimization sub-problems are solved simultaneously across different processing cores, enabling the system to evaluate complex routing scenarios involving dozens of inference workers 714 and hundreds of anticipated future requests within acceptable latency bounds for real-time routing decisions.

In certain implementations, the system may support self-reflection capabilities where agentic AI agent system processor 702 can detect self-reflection workflow specifications embedded in the metadata and execute multiple reflection iterations without requiring additional requests from external AI agent workflows. In some examples, this internal processing capability may allow the system to return refined results after completing reflection processes entirely within the inference infrastructure.

For example, when an inference request with metadata 710 arrives (e.g., from one or more AI agent workflows) containing self-reflection indicators such as "reflection_enabled": true, "max_iterations": 3, and "quality_threshold": 0.85, the agentic AI agent system processor 702 may identify this as a self-reflection workflow and initiate internal processing that maintains the computational context within the inference infrastructure rather than requiring round-trip communications back to the external agent workflow. The self-reflection process may operate through an internal loop where the agentic AI agent system processor 702 coordinates with router 712 to maintain KV cache coherency across multiple reflection cycles. For example, when processing a code generation request that requires iterative refinement, the initial inference request with metadata 710 may contain specifications indicating an expected 4-5 reflection iterations with moderate token generation requirements (200-400 completion tokens per iteration) and shared prompt prefixes that enable cache optimization. In certain implementations, the agentic AI agent system processor 702 may detect these specifications and configure the inference worker 714 to maintain the computational state across reflection cycles, enabling the system to generate an initial response, evaluate its quality against the embedded criteria, and perform subsequent refinement iterations without releasing the allocated GPU resources or invalidating the KV cache state.

In some examples, the internal reflection processing may involve coordinated communication between the agentic AI agent system processor 702 and prefill worker 716 to optimize prompt chaining across iterations. For instance, when processing a customer support response that requires quality refinement, the system may receive metadata indicating a 3-iteration reflection workflow with specific quality criteria such as "empathy_score": ">0.8" and "solution_completeness": ">0.9". In certain cases, the agentic AI agent system processor 702 may coordinate with prefill worker 716 to prepare reflection prompts that build upon the previous iteration's output, such as "Given your previous response: [PREVIOUS_OUTPUT], please improve the empathy and completeness while maintaining accuracy," enabling the system to chain these prompts efficiently within the same inference session while leveraging the cached key-value pairs from the initial processing.

In certain implementations, the self-reflection capability may demonstrate significant performance advantages through cache reuse and reduced round-trip latency. In some examples, when processing a complex analytical task that traditionally would require 4 separate inference requests with individual round-trip times averaging 2.3 seconds each (totaling 9.2 seconds), the internal self-reflection processing may complete the entire iterative refinement cycle within a single inference session lasting approximately 4.7 seconds. This efficiency gain may result from the system's ability to maintain the KV cache state across iterations, enabling inference worker 714 to reuse computational work from previous reflection cycles while applying incremental improvements based on the quality feedback mechanisms embedded in the metadata.

In some cases, the internal processing capability may enable sophisticated quality convergence where the agentic AI agent system processor 702 monitors output quality metrics across reflection iterations and automatically terminates the process when quality thresholds are met. For example, when processing a technical documentation request with metadata specifying "target_accuracy": 0.95 and "max_iterations": 5, the system may execute 3 internal reflection cycles before determining that the generated content achieves 0.96 accuracy, at which point the agentic AI agent system processor 702 may terminate the reflection process early and return the refined result to the external AI agent workflow. This internal decision-making capability may demonstrate how the system optimizes both quality and computational efficiency by avoiding unnecessary reflection iterations while ensuring that output quality meets the specified criteria embedded in the metadata.

In certain examples, this internal processing capability may allow the system to return refined results after completing reflection processes entirely within the inference infrastructure, fundamentally transforming the interaction model between AI agent workflows and inference servers. In some implementations, rather than requiring the external agent workflow to manage the complexity of iterative refinement through multiple API calls, the system may accept a single inference request with comprehensive reflection metadata and return a fully refined result that has undergone multiple internal quality improvement cycles. This approach may enable AI agent workflows to achieve higher output quality while reducing the computational overhead and latency penalties typically associated with multi-step reflection processes, demonstrating how predictive workload visibility and intelligent infrastructure coordination can enable optimization strategies that were previously impossible with reactive serving architectures.

In certain implementations, router 712 may implement algorithms that jointly optimize cache affinity and queue length using real-time GPU metrics combined with forward-looking hints provided through the metadata. In some examples, these algorithms may use Thompson sampling policies that can foresee future demand patterns and make routing decisions that account for anticipated workload bursts.

In certain implementations, router 712 may implement linear programming (LP) or mixed-integer programming (MIP) solvers that can formulate the routing decision as a comprehensive optimization problem. In some examples, the system may define decision variables representing the assignment of each inference request to specific inference workers 714, with objective functions that minimize total expected latency while maximizing KV cache utilization efficiency. In some cases, router 712 may incorporate constraints including GPU memory limitations, maximum queue lengths per worker, and KV cache capacity restrictions, enabling the LP solver to find optimal routing solutions that account for both current system state and predicted future workload characteristics encoded in the metadata. In certain examples, these optimization approaches may be particularly effective when router 712 needs to handle complex resource allocation scenarios involving dozens of inference workers 714 with varying computational capabilities and cache configurations.

In some implementations, router 712 may employ Q-learning or deep Q-network (DQN) algorithms that can learn optimal routing policies through trial-and-error interactions with the inference infrastructure. In certain examples, the system may maintain Q-tables or neural networks that map state-action pairs to expected rewards, where states represent current system conditions (worker loads, cache utilization, committed future requests) and actions represent routing decisions to specific inference workers 714. In some cases, router 712 may implement experience replay mechanisms that store routing decisions and their outcomes, enabling the Q-learning algorithm to learn from historical performance data and progressively improve routing accuracy over time. In certain implementations, these reinforcement learning approaches may be particularly valuable when router 712 operates in dynamic environments where workload patterns change frequently, as the algorithm can adapt to new patterns through continuous learning.

In certain embodiments, router 712 may implement genetic algorithms that can evolve optimal routing strategies through iterative population-based optimization. In some examples, the system may represent routing solutions as chromosomes containing gene sequences that encode routing assignments for multiple inference requests, with fitness functions that evaluate solutions based on predicted latency reduction and cache optimization benefits. In some cases, router 712 may apply genetic operators including crossover, mutation, and selection to generate new routing solution candidates, enabling the algorithm to explore diverse routing strategies and converge toward optimal configurations that account for anticipated workload bursts. In certain implementations, these evolutionary approaches may be particularly effective when router 712 needs to optimize routing decisions across extended time horizons involving complex interdependencies between sequential inference requests.

In some implementations, router 712 may employ simulated annealing algorithms that can escape local optima and find globally optimal routing solutions through probabilistic acceptance of suboptimal intermediate decisions. In certain examples, the system may implement cooling schedules that gradually reduce the probability of accepting worse routing decisions over time, enabling router 712 to initially explore diverse routing strategies before converging toward optimal configurations. In some cases, router 712 may combine simulated annealing with other metaheuristic approaches such as tabu search or particle swarm optimization, creating hybrid algorithms that can leverage multiple optimization strategies to find superior routing solutions that jointly optimize cache affinity and queue length using real-time GPU metrics. In certain implementations, these approaches may be particularly valuable when router 712 operates in scenarios with highly variable workload characteristics where traditional optimization methods may become trapped in suboptimal routing patterns.

In certain embodiments, router 712 may implement alternative bandit algorithms such as Upper Confidence Bound (UCB), epsilon-greedy, or LinUCB approaches that can balance exploration and exploitation in routing decisions. In some examples, UCB algorithms may provide theoretical guarantees on regret bounds while maintaining computational efficiency, enabling router 712 to make routing decisions with confidence intervals that account for uncertainty in worker performance estimates. In some cases, LinUCB algorithms may be particularly effective when router 712 can model the relationship between routing decisions and expected rewards as linear functions of the feature vectors comprising current KV cache match levels, worker load metrics, and anticipated future request patterns. In certain implementations, these alternative bandit approaches may offer different trade-offs between exploration efficiency and computational overhead, allowing router 712 to select algorithms that are optimized for specific deployment scenarios and performance requirements while still leveraging the predictive metadata to make intelligent routing decisions that account for anticipated workload bursts.

In some cases, the system may pre-allocate resources for anticipated follow-up requests based on the predictive metadata, enabling inference worker 714 to maintain consistent performance even as agent workflows progress through multi-step reasoning processes. In certain examples, this proactive resource management may demonstrate how predictive workload visibility enables different resource allocation strategies compared to reactive serving approaches. The comprehensive integration shown in FIG. 7 may enable optimization insights ranging from KV cache population decisions and serving mode selection to worker capacity pre-allocation and prompt prefix caching strategies. In some examples, this holistic approach may allow inference servers to reduce tail latency and improve resource utilization across concurrent agent workflow executions through predictive workload management that extends beyond traditional reactive serving architectures.

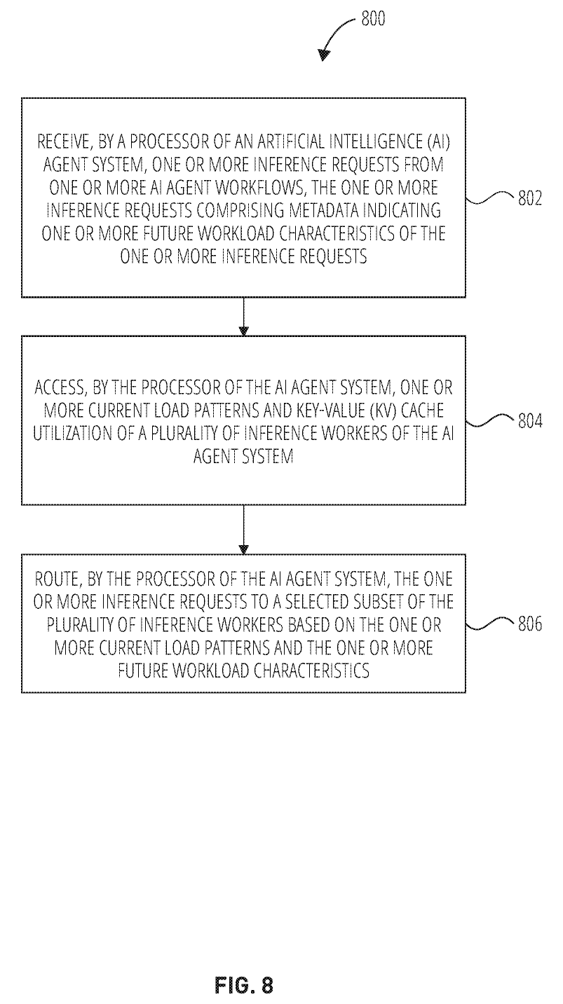

Now referring to FIG. 8, each block (or operation) of method 800, described herein, comprises a computing process that may be performed using any combination of hardware, firmware, and/or software. For instance, various functions may be carried out using one or more processors executing instructions stored in one or more memories. The method 800 may also be embodied as computer-usable instructions stored on computer storage media. The method 800 may be provided by a standalone application, a service or hosted service (standalone or in combination with another hosted service), as a microservice via an application programming interface (API), or a plug-in to another product, to name a few. In addition, the method 800 is described, by way of example, with respect to the AI agent system 104 of FIG. 1 which can be performed, at least in part, by the inference server 620 described in FIG. 7. However, this method 800 may additionally or alternatively be executed by any one system, or any combination of systems, including, but not limited to, those described herein. Specifically, the method 800 can be performed by any component shown in FIG. 1.

At operation 802, the AI agent system 104 receives, by an agentic AI agent system processor 702, one or more inference requests from one or more AI agent workflows, where the one or more inference requests comprise metadata indicating one or more future workload characteristics of the one or more inference requests. In some implementations, this receiving operation may involve the agentic AI agent system processor 702 accepting inference requests with metadata 710 that contain structured predictive information about anticipated workflow behavior patterns. In certain examples, the metadata may include expected numbers of reflection iterations, reflection prefix patterns, anticipated token generation requirements for each reflection iteration, expected numbers of subsequent requests, request type patterns, timing predictions including expected intervals between consecutive LM calls, and/or KV cache optimization hints based on identified common prompt prefixes. In some cases, the AI agent system 104 may extract this metadata from trained forecasting models that were created during offline profiling phases using historical execution data from similar workflows, where Hoeffding trees or other machine learning algorithms predict future workflow behavior characteristics including expected LM calls, anticipated completion token generation patterns, and resource utilization requirements.

At operation 804, the AI agent system 104 accesses, by the processor of the agentic AI agent system processor 702, one or more current load patterns and KV cache utilization of a plurality of inference workers 714 of the AI agent system. In certain implementations, this accessing operation may involve the agentic AI agent system processor 702 monitoring real-time operational data including current load patterns across the system, KV cache utilization statistics from multiple inference workers 714, current inference worker 714 load metrics, committed future request counts for each worker, and estimated timing parameters such as inter-request intervals and output generation times. In some examples, the agentic AI agent system processor 702 may simultaneously evaluate current KV cache match levels across the plurality of inference workers 714, analyze prompt prefix patterns to identify cache optimization opportunities, and calculate KV cache hit probabilities for different worker assignments based on identified prompt patterns. In certain cases, the accessing operation may include monitoring current system conditions such as GPU memory utilization, queue lengths per worker, processing capacity availability, and resource allocation status to provide comprehensive visibility into the current operational state of the inference infrastructure.

At operation 806, the AI agent system 104 routes, by the agentic AI agent system processor 702, the one or more inference requests to a selected subset of the plurality of inference workers 714 based on the one or more current load patterns and the one or more future workload characteristics. In some implementations, this routing operation may involve the router 712 implementing workload-aware routing decisions that combine current system state with predictive metadata to make intelligent allocation choices. In certain examples, the routing may employ Thompson sampling processes as the mathematical foundation for routing decisions, where bandit algorithms use feature vectors comprising current load metrics to generate reward functions through matrix multiplications. In some cases, the agentic AI agent system processor 702 may calculate opportunity costs for switching between inference workers versus maintaining current assignments, perform matrix multiplications on feature vectors to generate reward estimates for each available inference worker, and select optimal worker subsets by comparing exploration versus exploitation tradeoffs using Thompson sampling reward functions. In certain implementations, the routing operation may also involve analyzing request concurrency levels to determine resource allocation strategies, calculating expected GPU memory requirements based on both current load patterns and future workload characteristics, and transmitting KV cache recommendations to selected inference workers for proactive loading that reduces future latency. In some examples, the routing decisions may account for anticipated workload bursts and resource requirements rather than relying solely on point-in-time resource availability, enabling optimization strategies that were previously impossible with reactive serving approaches.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA’s OMNIVERSE and/or another platform, system, or service that uses USD or OpenUSD data types), systems implemented using an edge device, systems using or deploying one or more inference microservices, systems incorporating one or more machine learning models deployed in a service or microservice along with an OS-level virtualization package; systems incorporating one or more virtual machines (VMs), systems for performing synthetic data generation operations (e.g., using one or more neural rendering fields (NERFs), Gaussian splat techniques, diffusion models, transformer models, etc.), systems implemented at least partially in a data center, systems for performing conversational AI operations, systems implementing one or more LMs—such as one or more LLMs, one or more small language models (SLMs), one or more VLMs, one or more multi-modal LMs, etc., systems for performing light transport simulation, systems for performing collaborative content creation for 3D assets (e.g., using USD data, such as OpenUSD, computer aided design (CAD) data, two-dimensional (2D) and/or 3D graphics or design data, and/or other data types), systems implemented at least partially using cloud computing resources, and/or other types of systems.

### EXAMPLE LANGUAGE MODELS

In at least some embodiments, language models (e.g., the AI agent workflows 116), such as LLMs, SLMs, VLMs, multi-modal language models (MMLMs), and/or other types of generative AI may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These LMs may be considered “large,” in embodiments, based on the models being trained on massive datasets and having architectures with a large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, VLMs, or more generally MMLMs, may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/SLMs/VLMs/MMLMs/etc. architectures such as recurrent neural networks (RNNs) or LSTMs may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not need task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the LM toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model-alignment techniques. For example, in some embodiments, guardrails may be implemented to identify improper or undesired inputs (e.g., prompts) and/or outputs of the models. In doing so, the system may use the guardrails and/or other model-alignment techniques to either prevent a particular undesired input from being processed using the LLMs/SLMs/VLMs/MMLMs/etc., and/or preventing the output or presentation (e.g., display, audio output, etc.) of information generated using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MSLMs/MLMs/MMLMs/etc. may be configured to access or capable of accessing or using one or more plug-ins, APIs, databases, data stores, repositories, etc. For example, for certain tasks or operations that the model is not ideally suited for, the model may have instructions (e.g., as a result of training, and/or based on instructions in a given prompt) to access one or more plug-ins (e.g., third-party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires or benefits from a mathematical computation, the model may access one or more math plug-ins or APIs for help in solving the problem(s) and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources, such as APIs, plug-ins, and/or the like.

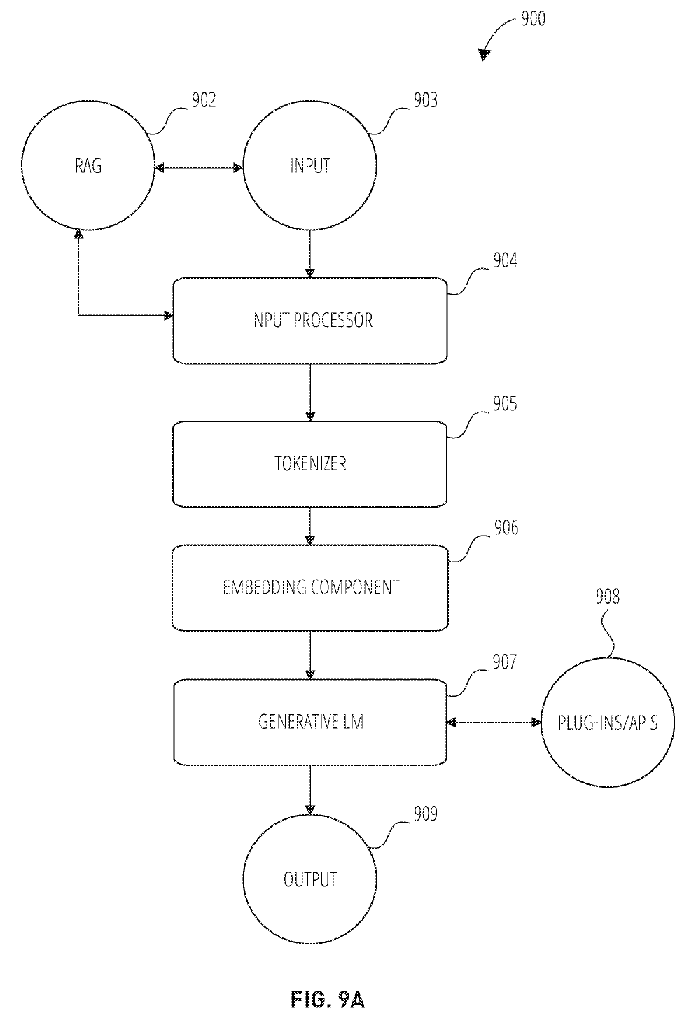

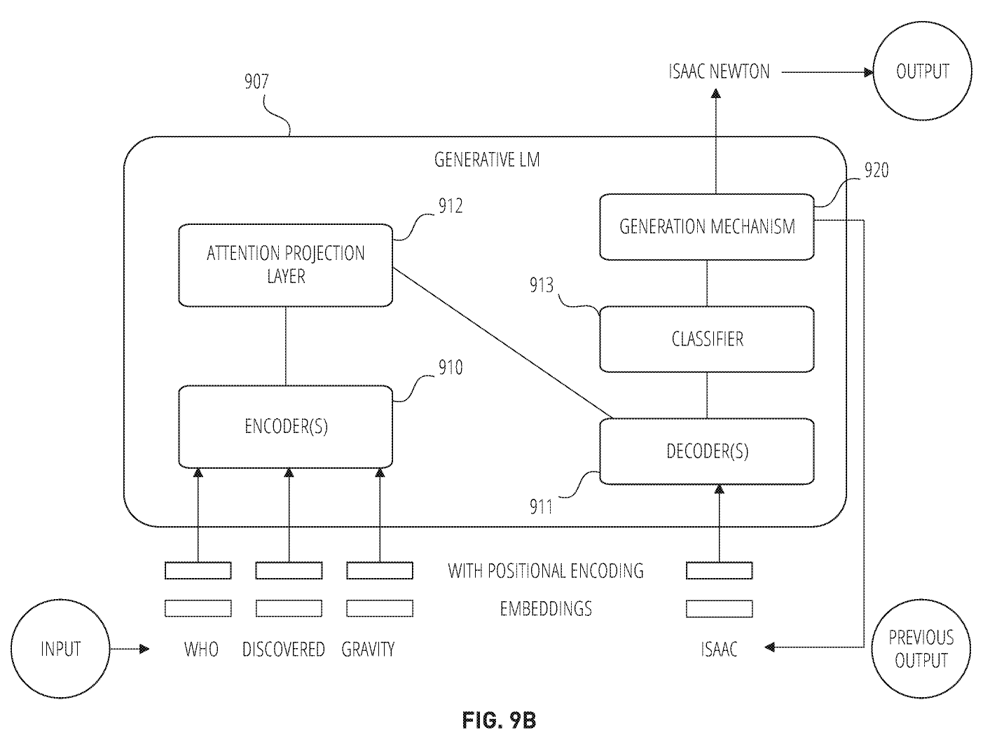

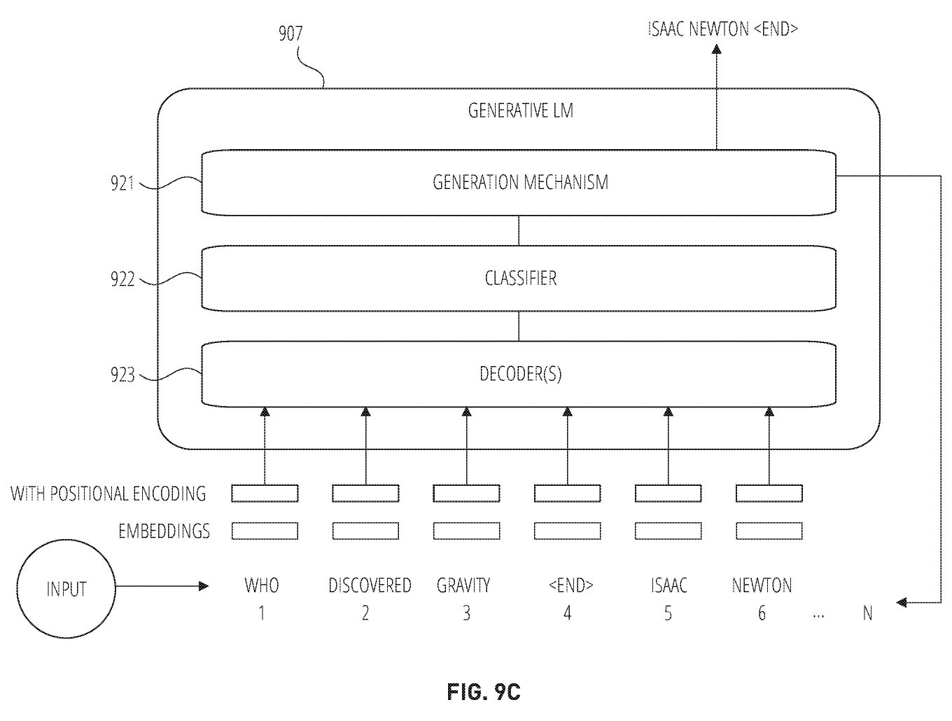

For example, and with reference to FIG. 9A, a generative LM 907 can access external resources through plug-ins/APIs 908 to enhance its capabilities beyond its internal knowledge base. When processing inputs, the generative LM 907 can intelligently determine when to utilize specific plug-ins/APIs 908 based on the requirements of the task. For example, when generating code, the generative LM 907 may access code execution environments through plug-ins/APIs 908 to test and validate solutions before providing them as output 909. The system enables coordinated use of multiple plug-ins/APIs 908 during generation, where the generative LM 907 can sequence different verification tools based on the specific requirements of the task. For instance, when solving mathematical problems, the generative LM 907 may first use symbolic computation plug-ins to verify equations, then access mathematical proof validation tools to check logical consistency, and finally employ formatting plug-ins to ensure proper mathematical notation in the output 909. This layered verification approach allows the generative LM 907 to produce outputs that are not only technically correct but also properly formatted and documented.

The plug-ins/APIs 908 integration is particularly valuable for verification tasks, as it allows the generative LM 907 to dynamically validate its outputs using domain-specific tools. For example, when generating code, the generative LM 907 can use syntax checkers, linters, and runtime environments accessed through plug-ins/APIs 908 to verify correctness, style, and execution behavior. The system can recursively apply these verification tools, using the feedback to refine the output 909 until it meets the required quality standards.

In some embodiments, multiple LMs (e.g., LLMs/SLMs/VLMs/MMLMs/etc.), multiple instances of the same LM, and/or multiple prompts provided to the same LM or instance of the same LM may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple LMs, e.g., LMs with different architectures and LMs trained on different (e.g., updated) corpora of data, may be provided with the same input query and prompt (e.g., set of constraints, conditioners, etc.). In one or more embodiments, the LMs may be different versions of the same foundation model. In one or more embodiments, at least one LM may be instantiated as multiple agents (e.g., more than one prompt may be provided to constrain, direct, or otherwise influence a style, a content, or a character, etc., of the output provided). In one or more example non-limiting embodiments, the same LM may be asked to provide output corresponding to a different role, perspective, character, or having a different base of knowledge, etc., as defined by a supplied prompt.

In any one of such embodiments, the output of two or more (e.g., each) LMs, two or more versions of at least one LM, two or more instanced agents of at least one LM, and/or two or more prompts provided to at least one LM may be further processed, e.g., aggregated, compared or filtered against, or used to determine (and provide) a consensus response. In one or more embodiments, the output from one LM—or version, instance, or agent—may be provided as input to another LM for further processing and/or validation. In one or more embodiments, a LM may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a LM may be used to determine the validity of an input source material for further processing or inclusion in a dataset. For example, a LM may be used to assess the presence (or absence) of a target word in a portion of text or an object in an image, with the text or image being annotated to note such presence (or lack thereof). Alternatively, the determination from the LM may be used to determine whether the source material should be included in a curated dataset, for example and without limitation.

FIG. 9A is a block diagram of an example generative LLM system 900, suitable for use in implementing at least some embodiments of the present disclosure. In the example illustrated in FIG. 9A, the generative LLM system 900 includes a RAG component 902, an input processor 904, a tokenizer 905, an embedding component 906, a generative LM 907 (which may include an LLM, a SLM, a VLM, a MLLM, etc.), and plug-ins/APIs 908.

At a high level, the input processor 904 may receive an input 903 comprising text and/or other types of input data (e.g., audio data, video data, image data, sensor data (e.g., LiDAR, RADAR, ultrasonic, etc.), 3D design data, CAD data, universal scene descriptor (USD) data – such as OpenUSD, etc.), depending on the architecture of the generative LM 907 (e.g., LLM/SLM/VLM/MMLM/etc.). In some embodiments, the input 903 includes plain text in the form of one or more sentences, paragraphs, and/or documents. Additionally or alternatively, the input 903 may include numerical sequences, precomputed embeddings (e.g., word or sentence embeddings), and/or structured data (e.g., in tabular formats, JSON, or XML). In some implementations in which the generative LM 907 is capable of processing multi-modal inputs, the input 903 may combine text (or may omit text) with image data, audio data, video data, design data, USD data, and/or other types of input data, such as but not limited to those described herein. Taking raw input text as an example, the input processor 904 may prepare raw input text in various ways. For example, the input processor 904 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 904 may remove stopwords to reduce noise and focus the generative LM 907 on more meaningful content. The input processor 904 may apply text normalization, for example, by converting all characters to lowercase, removing accents, and/or handling special cases like contractions or abbreviations to ensure consistency. These are just a few examples, and other types of input processing may be applied.

In some embodiments, a RAG component 902 (which may include one or more RAG models, and/or may be performed using the generative LM 907 itself) may be used to retrieve additional information to be used as part of the input 903 or prompt. The RAG component 902 may be used to enhance the input to the LLM/SLM/VLM/MMLM/etc. with external knowledge, so that answers to specific questions or queries or requests are more relevant—such as in a case where specific knowledge is involved. The RAG component 902 may fetch this additional information (e.g., grounding information, such as grounding text/image/video/audio/USD/CAD/etc.) from one or more external sources, which can then be fed to the LLM/SLM/VLM/MMLM/etc. along with the prompt to improve the accuracy of the responses or outputs of the model.

For example, in some embodiments, the input 903 may be generated using the query or input to the model (e.g., a question, a request, etc.) in addition to data retrieved using the RAG component 902. In some embodiments, the input processor 904 may analyze the input 903 and communicate with the RAG component 902 (or the RAG component 902 may be part of the input processor 904, in embodiments) in order to identify relevant text and/or other data to provide to the generative LM 907 as additional context or sources of information from which to identify the response, answer, or output 909, generally. For example, where the input 903 indicates that the user is interested in a desired tire pressure for a particular make and model of vehicle, the RAG component 902 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 902 may retrieve a prior stored conversation history—or at least a summary thereof—and include the prior conversation history along with the current ask/request as part of the input 903 to the generative LM 907.

For example, in some embodiments, the input 903 may be generated using the query or input to the model (e.g., a question, a request, etc.) in addition to data retrieved using the RAG component 902. This integration creates a comprehensive input package that combines the original task requirements with contextually relevant information for evaluation. The input 903 can take various forms, such as a structured data object containing multiple elements: the original query or task description, verification criteria for the AI agent workflows 116, and relevant reference information retrieved by the RAG component 902. When processing a task like "Implement a binary search tree insertion algorithm," the input 903 can include not only this request but also relevant documentation, test cases, and performance metrics that the AI agent workflows 116 will use to assess the generated solution.

The input processor 904 analyzes this enriched input package and communicates with the RAG component 902 to identify additional verification resources needed for comprehensive evaluation. The input processor 904 may analyze task characteristics to determine which verification approaches are most appropriate and prepares the contextual information needed for thorough evaluation.

The RAG component 902 might also retrieve historical evaluation data from previous optimization cycles. For instance, if a particular type of prompt has consistently led to higher-quality outputs in similar domains, the RAG component 902 can retrieve this historical context to inform the current optimization strategy. This ensures continuous improvement across evaluation sessions while applying lessons learned from previous optimization attempts. The AI agent system 104 orchestrates this process by determining which historical optimization data is relevant to the current task and how it should influence parameter adjustments, creating a self-improving system that progressively enhances output quality through intelligent evaluation and targeted refinement.

The RAG component 902 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 902 and the embeddings of the chunks along with the embeddings of the query may be compared to identify the most similar/related embeddings to the query, which may be supplied to the generative LM 907 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query)-to-graph query tool (NL-to-graph query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 902 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in’s REST interface such that the graph database is decoupled from the vector database and/or the embeddings models.

The tokenizer 905 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 907 to understand morphological variations and handle out-of-vocabulary words more effectively. Character-based tokenization represents each character as a separate token, enabling the generative LM 907 to process text at a fine-grained level. The choice of tokenization strategy may depend on factors such as the language being processed, the task at hand, and/or characteristics of the training dataset. As such, the tokenizer 905 may convert the (e.g., processed) text into a structured format according to tokenization schema being implemented in the particular embodiment.

The embedding component 906 may use any known embedding technique to transform discrete tokens into (e.g., dense, continuous vector) representations of semantic meaning. For example, the embedding component 906 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 903 includes image data/video data/etc., the input processor 904 may resize the data to a standard size compatible with the format of a corresponding input channel and/or may normalize pixel values to a common range (e.g., 0 to 1) to ensure a consistent representation, and the embedding component 906 may encode the image data using any known technique (e.g., using one or more convolutional neural networks (CNNs) to extract visual features). In some implementations in which the input 903 includes audio data, the input processor 904 may resample an audio file to a consistent sampling rate for uniform processing, and the embedding component 906 may use any known technique to extract and encode audio features—such as in the form of a spectrogram (e.g., a mel-spectrogram). In some implementations in which the input 903 includes video data, the input processor 904 may extract frames or apply resizing to extracted frames, and the embedding component 906 may extract features such as optical flow embeddings or video embeddings and/or may encode temporal information or sequences of frames. In some implementations in which the input 903 includes multi-modal data, the embedding component 906 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 907 and/or other components of the generative LLM system 900 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying nonlinear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 906 may apply an encoded representation of the input 903 to the generative LM 907, and the generative LM 907 may process the encoded representation of the input 903 to generate an output 909, which may include responsive text and/or other types of data.

As described herein, in some embodiments, the generative LM 907 may be configured to access or use—or be capable of accessing or using—plug-ins/APIs 908 (which may include one or more plug-ins, application programming interfaces (APIs), databases, data stores, repositories, etc.). For example, for certain tasks or operations that the generative LM 907 is not ideally suited for, the model may have instructions (e.g., as a result of training, and/or based on instructions in a given prompt, such as those retrieved using the RAG component 902) to access one or more plug-ins/APIs 908 (e.g., third-party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-ins/APIs 908 to the plug-ins/APIs 908, the plug-ins/APIs 908 may process the information and return an answer to the generative LM 907, and the generative LM 907 may use the response to generate the output 909. This process may be repeated—e.g., recursively—for any number of iterations and using any number of plug-ins/APIs 908 until an output 909 that addresses each ask/question/request/process/operation/etc. from the input 903 can be generated. As such, the model(s) may not only rely on its own knowledge from training on a large dataset(s) and/or from data retrieved using the RAG component 902, but also on the expertise or optimized nature of one or more external resources—such as the plug-ins/APIs 908.

The generative LM 907 can access external resources through plug-ins/APIs 908 to enhance its capabilities beyond its internal knowledge base. This integration is particularly valuable in evaluation and optimization workflows performed by the AI agent system 104, where the generative LM 907 may need to verify outputs or access specialized domain knowledge. When processing complex coding tasks, for instance, the generative LM 907 can identify syntax patterns in user input and automatically initiate API calls to code verification tools like interpreters or linters, incorporating proper programming standards while preserving the original output structure. The system may recursively query multiple specialized verification resources—progressing from code execution to syntax validation and finally to style analysis—before generating comprehensive evaluation data that maintains output quality while incorporating expert verification signals.

In optimization implementations, the system orchestrates complementary verification through targeted API integrations, allowing the generative LM 907 to access code interpreters for functional validation while simultaneously querying style checkers and mathematical validators when appropriate. This coordinated multi-source integration creates comprehensive evaluation perspectives impossible with single-source information models, while maintaining consistent output quality assessment. Similarly, in mathematical verification contexts, the generative LM 907 can reference symbolic problem solvers through API connections, execute computational verifications through code interpreters, and verify logical consistency through mathematical validation tools—all while maintaining its evaluation objectives and optimization goals within a coherent evaluation-optimization cycle.

Furthermore, the plugin integration architecture supports conditional access patterns where verification tools are dynamically selected based on the output domain. The input processor 904 can be configured through the API call structure to implement rules such as "use code interpreters when programming outputs are detected" or "reference mathematical validators when processing proofs." The generative LM 907 processes these different plugin response streams within the context of the evaluation objectives, enabling sophisticated verification processes where multiple tools can build upon each other's verification signals while maintaining consistent evaluation standards. This approach significantly enhances the evaluation accuracy beyond what either standard comparison or single-tool verification can achieve, as the system maintains both comprehensive verification capabilities and access to specialized knowledge resources appropriate to each output domain.

In some embodiments, the LLMs/SLMs/VLMs/MMLMs/etc. may be implemented as components within the AI agent workflows 116 that operate across multiple agent frameworks, requiring comprehensive performance analysis and optimization capabilities that extend beyond traditional model evaluation approaches. The AI agent system 104 described herein enables framework-agnostic instrumentation and analysis of these LM implementations regardless of whether they are deployed within LangChain, LlamaIndex, CrewAI, Semantic Kernel, or other agent framework environments. This approach allows developers to obtain unified performance insights across heterogeneous agent architectures where different LMs may be integrated with various tools, retrievers, and memory components, creating complex multi-framework workflows that require standardized analysis methodologies.

The LMs operating within these AI agent workflows 116 may be subject to comprehensive offline inference performance analysis through automated instrumentation that captures execution events, token usage patterns, latency characteristics, and behavioral metrics during workflow execution. The system may register custom callback handlers that intercept framework invocations including LLM calls, tool calls, and retriever operations, extracting relevant metadata such as input data, output data, token utilization, and execution timestamps from each intercepted invocation. This metadata extraction occurs transparently without requiring modifications to the underlying LM implementations, enabling developers to analyze performance efficiency metrics including latency analysis, bottleneck identification, concurrency analysis, and token efficiency measurements across different stages of agent workflow execution.

Furthermore, the performance analysis capabilities may include multi-concurrency simulation where LMs are evaluated under varying concurrent request loads to identify performance bottlenecks that manifest only during concurrent processing scenarios. The system may generate standardized invocation traces that capture end-to-end workflow execution data, enabling identification of nested function bottlenecks, workflow ancestry tracking, and behavioral characteristic analysis at levels of granularity previously impossible across multiple agent frameworks. These comprehensive performance insights enable optimization of LM deployment strategies, prompt engineering approaches, and resource allocation decisions while maintaining compatibility with existing observability platforms through standardized data export mechanisms that support OpenTelemetry-compatible formats and cross-framework visualization capabilities.

In some cases, the comprehensive offline profiling data collected through these analysis capabilities serves as the foundation for training specialized forecasting models that enable predictive optimization during runtime execution of AI agent workflows. The system employs machine learning algorithms, specifically Hoeffding trees, to analyze behavioral patterns extracted from the offline profiling data and train models that can predict future workflow behavior characteristics, including expected numbers of LM calls, anticipated token generation patterns, and timing intervals between consecutive requests. During runtime execution, these trained forecasting models generate predictive metadata that gets attached to inference server requests, providing servers with estimates of future work such as expected workflow execution patterns, anticipated resource utilization requirements, and cache optimization hints based on identified common prompt prefixes discovered through pattern mining algorithms. This predictive metadata enables inference servers 620 to make intelligent resource allocation decisions based on anticipated future workload rather than point-in-time resource availability, allowing for optimization strategies including KV cache population decisions, aggregated versus disaggregated serving selection, worker capacity pre-allocation, and prompt prefix caching that reduce tail latency and improve resource utilization across concurrent agent workflow executions. The forecasting models continuously learn and adapt during production deployment using ground truth data from completed workflow executions, creating a self-improving system that progressively enhances prediction accuracy and optimization effectiveness over time.

FIG. 9B is a block diagram of an example implementation in which the generative LM 907 includes a transformer encoder-decoder. For example, assume input text such as “Who discovered gravity” is tokenized (e.g., by the tokenizer 905 of FIG. 9A) into tokens such as words, and each token is encoded (e.g., by the embedding component 906 of FIG. 9A) into a corresponding embedding. Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 910 of the generative LM 907.

In an example implementation, the encoder(s) 910 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, and a self-attention score may be calculated for pairs of tokens by taking the dot product of the query vector with the corresponding key vectors, normalizing the resulting scores, multiplying by corresponding value vectors, and summing weighted value vectors. The encoder 910 may apply multi-headed attention in which the attention mechanism is applied multiple times in parallel with different learned weight matrices. Any number of encoders 910 may be cascaded to generate a context vector encoding the input. An attention projection layer 912 may convert the context vector into attention vectors (keys and values) for a decoder(s) 911.

In an example implementation, the decoder(s) 911 form a decoder stack, where each decoder includes a self-attention layer, an encoder-decoder self-attention layer that uses the attention vectors (keys and values) from the encoder 910 to focus on relevant parts of the input sequence, and a feedforward network. As with the encoder(s) 910, in an example transformer architecture, each token (e.g., word) flows through a separate path in the decoder(s) 911. During a first pass, the decoder(s) 911, a classifier 913, and a generation mechanism 920 may generate a first token, and the generation mechanism 920 may apply the generated token as an input during a second pass. The process may repeat in a loop, successively generating and adding tokens (e.g., words) to the output from the preceding pass and applying the token embeddings of the composite sequence with positional encodings as an input to the decoder(s) 911 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 910, except that it creates its queries from the layer below it and takes the keys and values (e.g., matrix) from the output of the encoder(s) 910.

As such, the decoder(s) 911 may output some decoded (e.g., vector) representation of the input being applied during a particular pass. The classifier 913 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 920 may select or sample a word or token based on a corresponding predicted probability (e.g., select the word with the highest predicted probability) and append it to the output from a previous pass, generating each word or token sequentially. The generation mechanism 920 may repeat the process, triggering successive decoder inputs and corresponding predictions until selecting or sampling a symbol or token that represents the end of the response, at which point the generation mechanism 920 may output the generated response.

FIG. 9C is a block diagram of an example implementation in which the generative LM 907 includes a decoder-only transformer architecture. For example, a decoder(s) 923 of FIG. 9C may operate similarly as the decoder(s) 911 of FIG. 9B except each of the decoder(s) 923 of FIG. 9C omits the encoder-decoder self-attention layer (since there is no encoder in this implementation). As such, the decoder(s) 923 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 923. As with the decoder(s) 911 of FIG. 9B, each token (e.g., word) may flow through a separate path in the decoder(s) 923, and the decoder(s) 923, a classifier 922, and a generation mechanism 921 may use auto-regression to sequentially generate one token at a time until predicting a symbol or token that represents the end of the response.

The classifier 922 and the generation mechanism 921 may operate similarly to the classifier 913 and the generation mechanism 920 of FIG. 9B, with the generation mechanism 921 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### EXAMPLE COMPUTING DEVICE

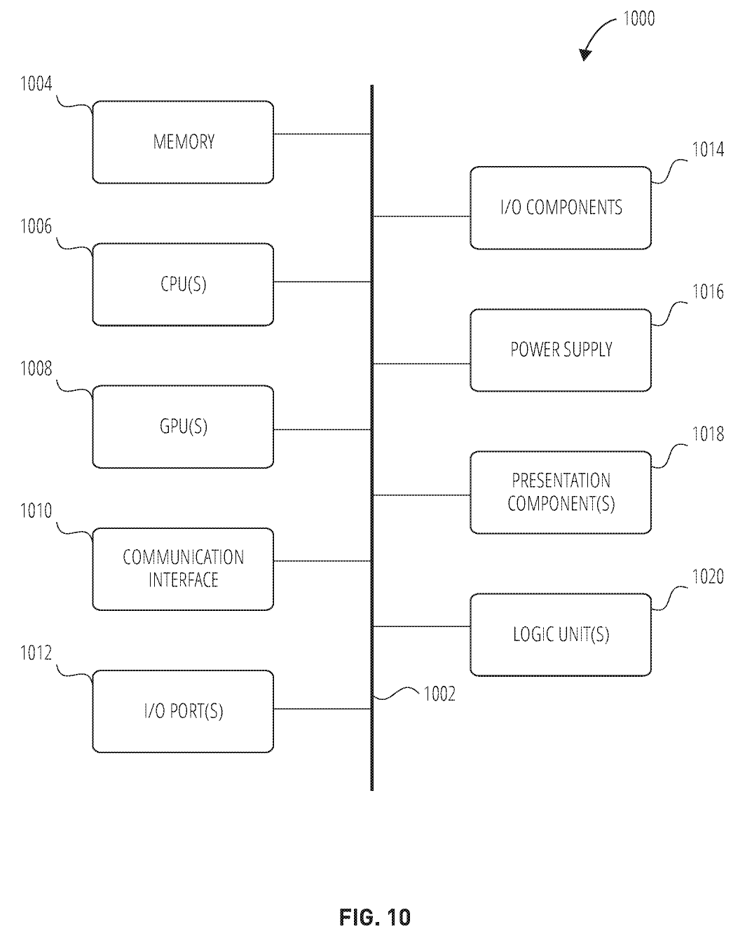

FIG. 10 is a block diagram of an example computing device 1000 suitable for use in implementing some embodiments of the present disclosure. The computing device 11000 may include an interconnect system 1002 that directly or indirectly couples the following devices: memory 1004, one or more central processing units (CPUs) 1006, one or more GPUs 1008, a communication interface 1010, input/output (I/O) ports 1012, input/output (I/O) components 1014, a power supply 1016, one or more presentation component(s) 1018 (e.g., display(s)), and one or more logic unit(s) 1020. In at least one embodiment, the computing device 1000 may comprise one or more VMs, and/or any of the components thereof may comprise virtual components (e.g., virtual hardware components). For non-limiting examples, one or more of the GPU(s) 1008 may comprise one or more vGPUs, one or more of the CPU(s) 1006 may comprise one or more vCPUs, and/or one or more of the logic unit(s) 1020 may comprise one or more virtual logic units. As such, a computing device 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component(s) 1018, such as a display device, may be considered I/O components 1014 (e.g., if the display is a touch screen). As another example, the CPU(s) 1006 and/or GPU(s) 1008 may include memory (e.g., the memory 1004 may be representative of a storage device in addition to the memory of the GPU(s) 1008, the CPU(s) 1006, and/or other components). As such, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU(s) 1006 may be directly connected to the memory 1004. Further, the CPU(s) 1006 may be directly connected to the GPU(s) 1008. Where there is direct, or point-to-point connection between components, the interconnect system 1002 may include a PCIe link to carry out the connection. In these examples, a PCI bus need not be included in the computing device 1000. The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

In some embodiments specifically related to implementing the AI agent system 104 described in FIG. 1, the computing device 1000 may be configured to provide framework-agnostic performance analysis of AI agent workflows 116 through automated instrumentation and standardized profiling capabilities. The memory 1004 may store custom callback handlers, intermediate step stream data, forecasting models, and/or standardized metadata extracted from different agent frameworks, while maintaining execution traces and performance metrics collected during multi-concurrency workflow analysis. The CPU(s) 1006, GPU(s) 1008, and/or logic unit(s) 1020 may work cooperatively to perform the distinct functions of the AI agent system 104, including automatic framework discovery, callback handler registration for intercepting framework invocations across LangChain, LlamaIndex, CrewAI, and Semantic Kernel implementations, metadata normalization into unified data models, and execution of specialized profiling algorithms that generate latency analysis, bottleneck identification, concurrency analysis, and token efficiency measurements that provide granular insights into workflow performance characteristics previously impossible to obtain across heterogeneous agent implementations.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPU(s) 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU(s) 1008 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic unit(s) 1020 may be part of and/or integrated into one or more of the CPU(s) 1006 and/or the GPU(s) 1008 and/or one or more of the logic unit(s) 1020 may be discrete components or otherwise external to the CPU(s) 1006 and/or the GPU(s) 1008. In embodiments, one or more of the logic unit(s) 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), VPUs, Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs) – which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., VPUs, Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), I/O elements, PCI or PCIe elements, and/or the like.

The communication interface 1010 may include one or more receivers, transmitters, and/or transceivers that allow the computing device 1000 to communicate with other computing devices via an electronic communication network, including wired and/or wireless communications. The communication interface 1010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, the logic unit(s) 1020 and/or communication interface 1010 may include one or more DPUs to transmit data received over a network and/or through the interconnect system 1002 directly to (e.g., a memory of) one or more GPU(s) 1008.

The I/O port(s) 1012 may allow the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. A NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may include one or more depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertial measurement unit (IMU)) that allow detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to allow the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### EXAMPLE DATA CENTER

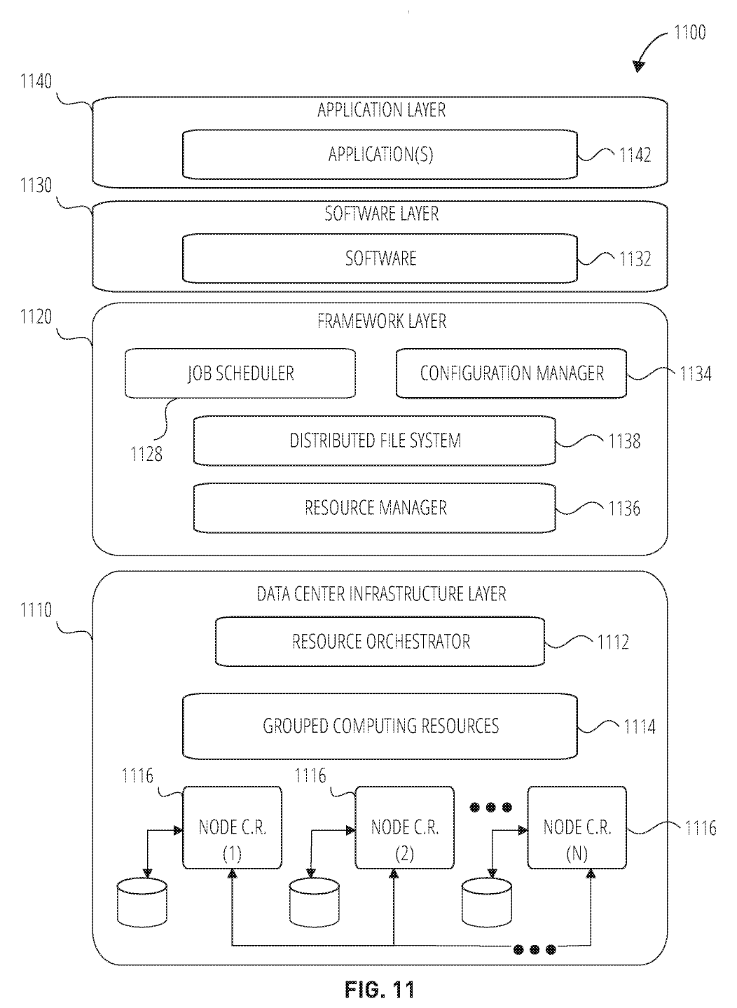

FIG. 11 illustrates an example data center 1100 that may be used in at least one embodiment of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources 1116 (“node C.R.s”), shown as (1)-(N), where “N” represents any whole, positive integer. In at least one embodiment, node computing resources 1116 may include, but are not limited to, any number of CPUs or other processors (including DPUs, accelerators, FPGAs, GPUs, etc.), memory devices (e.g., dynamic read-only memory), storage devices (e.g., solid state or disk drives), network (NW) I/O devices, network switches, VMs, power modules, and/or cooling modules, etc. In some embodiments, one or more nodes from among the node computing resources 1116 may correspond to a server having one or more of the above-mentioned computing resources. In addition, in some embodiments, the node computing resources 1116 may include one or more virtual components, such as vGPUs, vCPUs, and/or the like, and/or one or more of the node computing resources 1116 may correspond to a VM.

In at least one embodiment, the grouped computing resources 1114 may include separate groupings of the node computing resources 1116 housed within one or more racks (not shown), or many racks housed in data centers at various geographical locations (also not shown). Separate groupings of node computing resources 1116 within the grouped computing resources 1114 may include grouped compute, network, memory or storage resources that may be configured or allocated to support one or more workloads. In at least one embodiment, several node computing resources 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node computing resources 1116 and/or grouped computing resources 1114. In at least one embodiment, the resource orchestrator 1112 may include a software design infrastructure (SDI) management entity for the data center 1100. The resource orchestrator 1112 may include hardware, software, or some combination thereof.

In at least one embodiment, as shown in FIG. 11, the framework layer 1120 may include a job scheduler 1128, a configuration manager 1134, a resource manager 1136, and/or a distributed file system 1138. The framework layer 1120 may include a framework to support the software 1132 of the software layer 1130 and/or one or more application(s) 1142 of the application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark^{TM} (hereinafter “Spark”) that may use the distributed file system 1138 for large-scale data processing (e.g., "big data"). In at least one embodiment, the job scheduler 1128 may include a Spark driver to facilitate scheduling of workloads supported by various layers of the data center 1100. The configuration manager 1134 may be capable of configuring different layers such as the software layer 1130 and the framework layer 1120 including Spark and the distributed file system 1138 for supporting large-scale data processing. The resource manager 1136 may be capable of managing clustered or grouped computing resources mapped to or allocated for support of the distributed file system 1138 and the job scheduler 1128. In at least one embodiment, clustered or grouped computing resources may include the grouped computing resources 1114 at the data center infrastructure layer 1110. The resource manager 1136 may coordinate with the resource orchestrator 1112 to manage these mapped or allocated computing resources.

In at least one embodiment, the software 1132 included in the software layer 1130 may include software used by at least portions of the node computing resources 1116, grouped computing resources 1114, and/or the distributed file system 1138 of the framework layer 1120. One or more types of software may include, but are not limited to, Internet web page search software, e-mail virus scan software, database software, and streaming video content software.

In at least one embodiment, the application(s) 1142 included in the application layer 1140 may include one or more types of applications used by at least portions of the node computing resources 1116, grouped computing resources 1114, and/or distributed file system 1138 of the framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of the configuration manager 1134, resource manager 1136, and resource orchestrator 1112 may implement any number and type of self-modifying actions based on any amount and type of data acquired in any technically feasible fashion. Self-modifying actions may relieve a data center operator of the data center 1100 from making bad configuration decisions and possibly avoiding underutilized and/or poor performing portions of a data center. Each layer of the data center 1100 contributes functionality to the AI agent system 104.

The data center 1100 may include tools, services, software, or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, ASICs, GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services.

The AI agent system 104 of FIG. 1 is designed to perform comprehensive offline inference performance analysis of AI agent workflows 116 across multiple deployment layers of the data center 1100 without requiring modifications to existing agent implementations, while also enabling intelligent online inference optimization through predictive workload forecasting and metadata-driven server routing. The AI agent system 104 can automatically discover and instrument agent workflows built using different frameworks such as LangChain, LlamaIndex, CrewAI, and Semantic Kernel while maintaining complete end-to-end observability through standardized intermediate step streams across all layers of the data center 1100 infrastructure. Additionally, the system trains forecasting models using the collected offline profiling data to predict future workflow behavior patterns and resource utilization characteristics, enabling the generation of predictive metadata during runtime execution that gets attached to inference requests for intelligent server-side resource allocation decisions.

At the application layer 1140, the AI agent system 104 can analyze application(s) 1142 that implement AI agent workflows 116 by registering custom callback handlers for each discovered agent framework to intercept framework invocations. The API server 114 coordinates with application(s) 1142 running at the application layer 1140 to collect execution events from agent workflows during multi-concurrency evaluation, enabling the profiler component 112 to generate performance efficiency metrics including latency analysis, bottleneck identification, and token efficiency measurements that help developers understand how their agent implementations behave across different deployment scenarios. The AI agent system 104 also employs pattern mining algorithms, specifically PrefixSpan, to automatically identify common prompt prefixes across multiple agent workflow executions, incorporating this information into predictive metadata that enables inference servers to make intelligent KV cache population decisions and pre-populate caches with frequently occurring prompt structures.

Within the software layer 1130, the AI agent system 104 interfaces with software 1132 components to extract metadata including input data, output data, token usage statistics, and execution timestamps from intercepted framework invocations. The evaluation system 106 works with the software layer 1130 to normalize extracted metadata across different frameworks into a unified data model that gets published to an intermediate step stream, enabling the telemetry component 124 to collect comprehensive execution traces that capture end-to-end workflow execution data including function ancestry information and hierarchical relationships between workflow components. This comprehensive behavioral data serves as the foundation for training forecasting models, specifically Hoeffding trees, that can predict future workflow behavior including expected numbers of LM calls, anticipated token generation patterns, and timing characteristics based on historical execution patterns.

At the framework layer 1120, the AI agent system 104 coordinates with the job scheduler 1128, configuration manager 1134, and resource manager 1136 to enable framework-agnostic performance analysis across heterogeneous agent implementations while also supporting predictive optimization capabilities. The configuration 110 component works with the configuration manager 1134 to define evaluation criteria, performance thresholds, and analysis parameters that guide both the profiling process and forecasting model training. The profiler component 112 leverages the distributed file system 1138 to store standardized invocation traces and execution data that enable comprehensive behavioral analysis across multiple framework boundaries, while trained forecasting models generate predictive metadata during runtime execution that includes estimates of future work, expected workflow execution patterns, and anticipated resource utilization requirements.

At the data center infrastructure layer 1110, the AI agent system 104 communicates with the resource orchestrator 1112 to coordinate performance analysis across grouped computing resources 1114 and node computing resources 1116 where agent workflows are deployed, while also enabling predictive workload management through forecasting-driven resource allocation. The observability platform 126 exports trace data to infrastructure monitoring systems through the resource orchestrator 1112, enabling cross-framework observability where agent workflows built in one framework can be visualized using tools associated with different frameworks. The comprehensive instrumentation capabilities combined with predictive forecasting enable the AI agent system 104 to provide granular insights into workflow performance characteristics and intelligent resource allocation decisions based on predicted future workload rather than point-in-time resource availability, fundamentally transforming how agent workflows interact with inference infrastructure across the data center 1100 deployment.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device 1000 of FIG. 10—e.g., each device may include similar components, features, and/or functionality of the computing device 1000. In addition, where backend devices (e.g., servers, NAS, etc.) are implemented, the backend devices may be included as part of the data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more APIs). The framework layer may be, but is not limited to, a type of free and open-source software web application framework such as that may use a distributed file system for large-scale data processing (e.g., "big data").

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or operations or combinations of steps or operations similar to the ones described in this document, in conjunction with other present or future technologies. Moreover, although the terms “step” and/or “block” and/or “operation” may be used herein to connote different elements of methods employed, the terms should not be interpreted as implying any particular order among or between various steps herein disclosed unless and except when the order of individual steps is explicitly described.

### EXAMPLES

Specific example embodiments are now described. In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1. One or more processors comprising processing circuitry to perform operations comprising: receiving, by a processor of an artificial intelligence (AI) agent system, one or more inference requests from one or more AI agent workflows, the one or more inference requests comprising metadata indicating one or more future workload characteristics of the one or more inference requests; accessing, by the processor of the AI agent system, one or more current load patterns and key-value (KV) cache utilization of a plurality of inference workers of the AI agent system; and routing, by the processor of the AI agent system, the one or more inference requests to a selected subset of the plurality of inference workers based on the one or more current load patterns and the one or more future workload characteristics.

Example 2. The one or more processors of Example 1, wherein the operations comprise: extracting metadata indicating an expected number of reflection iterations and reflection prefix patterns; calculating anticipated token generation requirements for each reflection iteration; and formatting the metadata for attachment to the one or more inference requests.

Example 3. The one or more processors of any one of Examples 1-2, wherein the operations comprise: implementing, by the processor, a model for workload-aware routing decisions; calculating, by the model, one or more reward functions for each of the plurality of inference workers based on the one or more current load patterns and one or more future workload characteristics; and routing the one or more inference requests based on the one or more reward functions.

Example 4. The one or more processors of Example 3, wherein the model comprises a Thompson sampling process.

Example 5. The one or more processors of Example 4, wherein the operations comprise: training bandit algorithms using one or more feature vectors comprising current load metrics of the plurality of inference workers; performing one or more matrix multiplications to generate the one or more reward functions; receiving latency feedback from one or more completed requests; and updating bandit matrices based on the latency feedback.

Example 6. The one or more processors of any one of Examples 1-5, wherein the operations comprise: detecting self-reflection workflow specifications from the metadata; performing, by the processor, one or more self-reflection iterations without receiving additional requests from the one or more AI agent workflows; and returning a result to the one or more AI agent workflows by the processor in response to performing the one or more self-reflection iterations.

Example 7. The one or more processors of any one of Examples 1-6, wherein the operations comprise: analyzing request concurrency levels to determine resource allocation; calculating expected GPU memory requirements based on the one or more current load patterns and the one or more future workload characteristics; and balancing the one or more current load patterns with predicted future demand of the AI agent workflows.

Example 8. The one or more processors of Example 7, wherein the operations comprise: transmitting one or more KV cache recommendations to the selected subset of the plurality of inference workers for proactive loading.

Example 9. The one or more processors of any one of Examples 1-8, wherein the operations comprise: generating feature vectors comprising at least one of current KV cache match levels, current inference worker load metrics, committed future request counts for each inference worker, or estimated timing parameters including inter-request intervals and output generation times; calculating opportunity costs for switching between inference workers versus maintaining current inference worker assignments using the feature vectors; performing matrix multiplications on the feature vectors to generate reward estimates for each available inference worker; updating one or more Thompson sampling reward functions based on actual latency feedback from completed inference requests; and selecting the subset of the plurality of inference workers by comparing exploration versus exploitation tradeoffs using the one or more Thompson sampling reward functions.

Example 10. The one or more processors of any one of Examples 1-9, wherein the operations comprise: monitoring current KV cache utilization across the plurality of inference workers; analyzing prompt prefix patterns to identify KV cache optimization opportunities; calculating KV cache hit probabilities for different inference worker assignments based on the prompt prefix patterns; and generating KV cache affinity scores for routing decisions using the KV cache hit probabilities.

Example 11. The one or more processors of any one of Examples 1-10, the one or more future workload characteristics comprising at least one of: an expected number of subsequent requests of the one or more AI agent workflows; or request type patterns of the one or more AI agent workflows.

Example 12. The one or more processors of any one of Examples 1-11, wherein the operations comprise: collecting offline profiling data from executions associated with the one or more AI agent workflows; training one or more forecasting models using one or more Hoeffding trees for streaming data learning; analyzing execution traces to identify behavioral patterns and resource utilization characteristics; and generating training datasets that capture statistical distributions of workflow execution patterns of the AI agent workflows.

Example 13. The one or more processors of Example 12, wherein generating the offline profiling data comprises: inspecting source code of the one or more AI agent workflows to identify undeclared agent frameworks and automatically discovering language model frameworks used in function definitions by analyzing at least one of code structure or library imports; registering custom callback handlers for each identified agent framework to intercept framework invocations and extract information including at least one of input data, output data, or token usage from the intercepted framework invocations; normalizing the extracted information across different frameworks into a unified data model and publishing the normalized information to an intermediate step stream; and executing the one or more AI agent workflows across multiple concurrency levels while collecting execution traces and generating standardized invocation traces that capture end-to-end workflow execution data for the offline profiling data.

Example 14. The one or more processors of any one of Examples 12-13, wherein the operations comprise: implementing the one or more forecasting models as the one or more Hoeffding trees to learn from streaming data during production deployment; training the one or more forecasting models using one or more pattern mining algorithms to identify common prompt prefixes across multiple workflow executions; calculating at least one of expected number of language model calls, expected completion tokens, or expected time intervals between calls based on historical execution patterns of the one or more AI agent workflows; and updating the one or more forecasting models during runtime execution using ground truth data from completed workflow executions.

Example 15. The one or more processors of any one of Examples 1-14, wherein the one or more processors are comprised in at least one of: a control system for an autonomous or semi-autonomous machine; a perception system for the autonomous or semi-autonomous machine; a system for performing simulation operations; a system for performing digital twin operations; a system for performing light transport simulation; a system for performing collaborative content creation for three-dimensional (3D) assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational artificial intelligence (AI) operations; a system implementing one or more multi-modal language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system using or deploying one or more inference microservices; a system incorporating one or more machine learning models deployed in a service or microservice along with an OS-level virtualization package; a system implemented at least partially in a data center; or a system implemented at least partially using cloud computing resources.

Example 16. A system comprising one or more processors to perform operations comprising: receiving, by a processor of an artificial intelligence (AI) agent system, one or more inference requests from one or more AI agent workflows, the one or more inference requests being part of a sequence of related inference requests and indicating one or more future workload characteristics of the one or more inference requests; accessing, by the processor of the AI agent system, one or more current load patterns and key-value (KV) cache utilization of a plurality of inference workers of the AI agent system; and routing, by the processor of the AI agent system, the one or more inference requests to at least one selected inference worker from the plurality of inference workers to optimize a total latency for the sequence of related inference requesets, based on the one or more current load patterns and the one or more future workload characteristics.

Example 17. The system of Example 16, wherein the system is comprised in at least one of: a control system for an autonomous or semi-autonomous machine; a perception system for the autonomous or semi-autonomous machine; a system for performing simulation operations; a system for performing digital twin operations; a system for performing light transport simulation; a system for performing collaborative content creation for three-dimensional (3D) assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational artificial intelligence (AI) operations; a system implementing one or more multi-modal language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system using or deploying one or more inference microservices; a system incorporating one or more machine learning models deployed in a service or microservice along with an OS-level virtualization package; a system implemented at least partially in a data center; or a system implemented at least partially using cloud computing resources.

Example 18. A method comprising: receiving, by a processor of an artificial intelligence (AI) agent system, one or more inference requests from one or more AI agent workflows, the one or more inference requests being part of a sequence of related inference requests and indicating one or more future workload characteristics of the one or more inference requests; accessing, by the processor of the AI agent system, one or more current load patterns and key-value (KV) cache utilization of a plurality of inference workers of the AI agent system; and routing, by the processor of the AI agent system, the one or more inference requests to at least one selected inference worker from the plurality of inference workers to optimize a total latency for the sequence of related inference requests, based on the one or more current load patterns and the one or more future workload characteristics.

Example 19. The method of any one of Examples 18, the one or more future workload characteristics comprising at least one of expected number of subsequent requests of the one or more AI agent workflows or request type patterns of the one or more AI agent workflows.

Example 20. The method of any one of Examples 18-19, wherein the method is performed by at least one of: a control system for an autonomous or semi-autonomous machine; a perception system for the autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational artificial intelligence (AI) operations; a system implementing one or more multi-modal language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system using or deploying one or more inference microservices; a system incorporating one or more machine learning models deployed in a service or microservice along with an OS-level virtualization package; a system implemented at least partially in a data center; or a system implemented at least partially using cloud computing resources.

What is claimed is:

1. One or more processors comprising processing circuitry to perform operations comprising:
receiving, by a processor of an artificial intelligence (AI) agent system, one or more inference requests from one or more AI agent workflows, the one or more inference requests comprising metadata indicating one or more future workload characteristics of the one or more inference requests;
accessing, by the processor of the AI agent system, one or more current load patterns and key-value (KV) cache utilization of a plurality of inference workers of the AI agent system; and
routing, by the processor of the AI agent system, the one or more inference requests to a selected subset of the plurality of inference workers based on the one or more current load patterns and the one or more future workload characteristics.

2. The one or more processors of claim 1, wherein the operations comprise:
extracting metadata indicating an expected number of reflection iterations and reflection prefix patterns;
calculating anticipated token generation requirements for each reflection iteration; and
formatting the metadata for attachment to the one or more inference requests.

3. The one or more processors of claim 1, wherein the operations comprise:
implementing, by the processor, a model for workload-aware routing decisions;
calculating, by the model, one or more reward functions for each of the plurality of inference workers based on the one or more current load patterns and one or more future workload characteristics; and
routing the one or more inference requests based on the one or more reward functions.

4. The one or more processors of claim 3, wherein the model comprises a Thompson sampling process.

5. The one or more processors of claim 4, wherein the operations comprise:
training bandit algorithms using one or more feature vectors comprising current load metrics of the plurality of inference workers;
performing one or more matrix multiplications to generate the one or more reward functions;
receiving latency feedback from one or more completed requests; and
updating bandit matrices based on the latency feedback.

6. The one or more processors of claim 1, wherein the operations comprise:
detecting self-reflection workflow specifications from the metadata;
performing, by the processor, one or more self-reflection iterations without receiving additional requests from the one or more AI agent workflows; and
returning a result to the one or more AI agent workflows by the processor in response to performing the one or more self-reflection iterations.

7. The one or more processors of claim 1, wherein the operations comprise:
analyzing request concurrency levels to determine resource allocation;
calculating expected GPU memory requirements based on the one or more current load patterns and the one or more future workload characteristics; and
balancing the one or more current load patterns with predicted future demand of the AI agent workflows.

8. The one or more processors of claim 7, wherein the operations comprise:
transmitting one or more KV cache recommendations to the selected subset of the plurality of inference workers for proactive loading.

9. The one or more processors of claim 1, wherein the operations comprise:
generating feature vectors comprising at least one of current KV cache match levels, current inference worker load metrics, committed future request counts for each inference worker, or estimated timing parameters including inter-request intervals and output generation times;
calculating opportunity costs for switching between inference workers versus maintaining current inference worker assignments using the feature vectors;
performing matrix multiplications on the feature vectors to generate reward estimates for each available inference worker;
updating one or more Thompson sampling reward functions based on actual latency feedback from completed inference requests; and
selecting the subset of the plurality of inference workers by comparing exploration versus exploitation tradeoffs using the one or more Thompson sampling reward functions.

10. The one or more processors of claim 1, wherein the operations comprise:
monitoring current KV cache utilization across the plurality of inference workers;
analyzing prompt prefix patterns to identify KV cache optimization opportunities;
calculating KV cache hit probabilities for different inference worker assignments based on the prompt prefix patterns; and
generating KV cache affinity scores for routing decisions using the KV cache hit probabilities.

11. The one or more processors of claim 1, the one or more future workload characteristics comprising at least one of:
an expected number of subsequent requests of the one or more AI agent workflows; or
request type patterns of the one or more AI agent workflows.

12. The one or more processors of claim 1, wherein the operations comprise:
collecting offline profiling data from executions associated with the one or more AI agent workflows;
training one or more forecasting models using one or more Hoeffding trees for streaming data learning;
analyzing execution traces to identify behavioral patterns and resource utilization characteristics; and
generating training datasets that capture statistical distributions of workflow execution patterns of the AI agent workflows.

13. The one or more processors of claim 12, wherein generating the offline profiling data comprises:
inspecting source code of the one or more AI agent workflows to identify undeclared agent frameworks and automatically discovering language model frameworks used in function definitions by analyzing at least one of code structure or library imports;
registering custom callback handlers for each identified agent framework to intercept framework invocations and extract information including at least one of input data, output data, or token usage from the intercepted framework invocations;
normalizing the extracted information across different frameworks into a unified data model and publishing the normalized information to an intermediate step stream; and
executing the one or more AI agent workflows across multiple concurrency levels while collecting execution traces and generating standardized invocation traces that capture end-to-end workflow execution data for the offline profiling data.

14. The one or more processors of claim 13, wherein the operations comprise:
implementing the one or more forecasting models as the one or more Hoeffding trees to learn from streaming data during production deployment;
training the one or more forecasting models using one or more pattern mining algorithms to identify common prompt prefixes across multiple workflow executions;
calculating at least one of expected number of language model calls, expected completion tokens, or expected time intervals between calls based on historical execution patterns of the one or more AI agent workflows; and
updating the one or more forecasting models during runtime execution using ground truth data from completed workflow executions.

15. The one or more processors of claim 1, wherein the one or more processors are comprised in at least one of:
a control system for an autonomous or semi-autonomous machine;
a perception system for the autonomous or semi-autonomous machine;
a system for performing simulation operations;
a system for performing digital twin operations;
a system for performing light transport simulation;
a system for performing collaborative content creation for three-dimensional (3D) assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system incorporating one or more machine learning models deployed in a service or microservice along with an OS-level virtualization package;
a system implemented at least partially in a data center; or
a system implemented at least partially using cloud computing resources.

16. A system comprising one or more processors to perform operations comprising:
receiving, by a processor of an artificial intelligence (AI) agent system, one or more inference requests from one or more AI agent workflows, the one or more inference requests being part of a sequence of related inference requests and indicating one or more future workload characteristics of the one or more inference requests;
accessing, by the processor of the AI agent system, one or more current load patterns and key-value (KV) cache utilization of a plurality of inference workers of the AI agent system; and
routing, by the processor of the AI agent system, the one or more inference requests to at least one selected inference worker from the plurality of inference workers to optimize a total latency for the sequence of related inference requesets, based on the one or more current load patterns and the one or more future workload characteristics.

17. The system of claim 16, wherein the system is comprised in at least one of:
a control system for an autonomous or semi-autonomous machine;
a perception system for the autonomous or semi-autonomous machine;
a system for performing simulation operations;
a system for performing digital twin operations;
a system for performing light transport simulation;
a system for performing collaborative content creation for three-dimensional (3D) assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system incorporating one or more machine learning models deployed in a service or microservice along with an OS-level virtualization package;
a system implemented at least partially in a data center; or
a system implemented at least partially using cloud computing resources.

18. A method comprising:
receiving, by a processor of an artificial intelligence (AI) agent system, one or more inference requests from one or more AI agent workflows, the one or more inference requests being part of a sequence of related inference requests and indicating one or more future workload characteristics of the one or more inference requests;
accessing, by the processor of the AI agent system, one or more current load patterns and key-value (KV) cache utilization of a plurality of inference workers of the AI agent system; and
routing, by the processor of the AI agent system, the one or more inference requests to at least one selected inference worker from the plurality of inference workers to optimize a total latency for the sequence of related inference requests, based on the one or more current load patterns and the one or more future workload characteristics.

19. The method of claim 18, the one or more future workload characteristics comprising at least one of expected number of subsequent requests of the one or more AI agent workflows or request type patterns of the one or more AI agent workflows.

20. The method of claim 18, wherein the method is performed by at least one of:
a control system for an autonomous or semi-autonomous machine;
a perception system for the autonomous or semi-autonomous machine;
a system for performing simulation operations;
a system for performing digital twin operations;
a system for performing light transport simulation;
a system for performing collaborative content creation for three-dimensional (3D) assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system incorporating one or more machine learning models deployed in a service or microservice along with an OS-level virtualization package;
a system implemented at least partially in a data center; or
a system implemented at least partially using cloud computing resources.
